(19) United States
(12) Patent Application Publication
(10) Pub. No.: US 2011/0082668 A1
(43) Pub. Date: Apr. 7, 2011

(54) SYSTEMS AND METHODS FOR ESTABLISHING AN ENVIRONMENTAL REPRESENTATION

(76) Inventors: M. Teresa Escrig, Yelm, WA (US); Juan Carlos Peris, Castellon (ES)

(21) Appl. No.: 12/899,487

(22) Filed: Oct. 6, 2010

Related U.S. Application Data
(60) Provisional application No. 61/249,121, filed on Oct. 6, 2009.
(60) Provisional application No. 61/259,194, filed on Nov. 8, 2009.
(60) Provisional application No. 61/347,632, filed on May 24, 2010.

(51) Int. Cl. G06F 17/50; G06F 19/00

(52) U.S. Cl. 703/1; 702/5

(57) ABSTRACT

This invention relates generally to robotics, and more specifically, to systems and methods for establishing an environmental representation. In one embodiment, the invention includes a method of operations including determining quantitative data relating to one or more landmarks; determining qualitative data relating to the one or more landmarks; and establishing at least a portion of an environmental representation using the quantitative data and/or the qualitative data.

### PRIORITY CLAIM

This application is a non-provisional of provisional application 61/249,121 filed Oct. 6, 2009, provisional application 61/259,194 filed Nov. 8, 2009, and provisional application 61/347,632 filed May 24, 2010. This application claims the benefit of and/or priority to each of the foregoing applications. The foregoing applications are incorporated by reference in their entirety as if fully set forth herein.

### FIELD OF THE INVENTION

This invention relates generally to robotics, and more specifically, to systems and methods for establishing an environmental representation.

### SUMMARY

This invention relates generally to robotics, and more specifically, to systems and methods for establishing an environmental representation. In one embodiment, the invention includes a method of operations including determining quantitative data relating to one or more landmarks; determining qualitative data relating to the one or more landmarks; and establishing at least a portion of an environmental representation using the quantitative data and/or the qualitative data.

### BRIEF DESCRIPTION OF THE DRAWINGS

Embodiments of the present invention are described in detail below with reference to the following drawings:

FIG. 1 is a block diagram of a method for establishing an environmental representation, in accordance with an embodiment of the invention;

FIGS. 2-6 are block diagrams of various embodiments of a method for establishing an environmental representation, in accordance with various embodiments of the invention;

FIG. 7 is a block diagram of a method for establishing an environmental representation, in accordance with an embodiment of the invention;

FIG. 8 is a block diagram of various embodiments of a method for establishing an environmental representation, in accordance with various embodiments of the invention;

FIG. 9 is a block diagram of a method for establishing an environmental representation, in accordance with an embodiment of the invention;

FIG. 10 is a system diagram of one or more software applications embodied in computer readable media for establishing an environmental representation, in accordance with an embodiment of the invention;

FIG. 11 is a system diagram of one or more software applications embodied in a device configured for association with machinery for establishing an environmental representation, in accordance with an embodiment of the invention;

FIG. 12 is a system diagram of one or more software applications embodied in a robot for establishing an environmental representation, in accordance with an embodiment of the invention;

FIG. 13 is a component diagram of a system for establishing an environmental representation, in accordance with an embodiment of the invention; and

FIG. 14 is a plan diagram of a robot within an environment for establishing an environmental representation, in accordance with an embodiment of the invention;

FIG. 15 is a diagram of a linear field arrangement relative to two landmarks, in accordance with an embodiment of the invention;

FIG. 16 is a diagram illustrating qualitative determinations based on previously determined qualitative data, in accordance with an embodiment of the invention; and

APPENDIX A discloses various embodiments of the invention including hardware for implementing methods disclosed herein.

### DETAILED DESCRIPTION

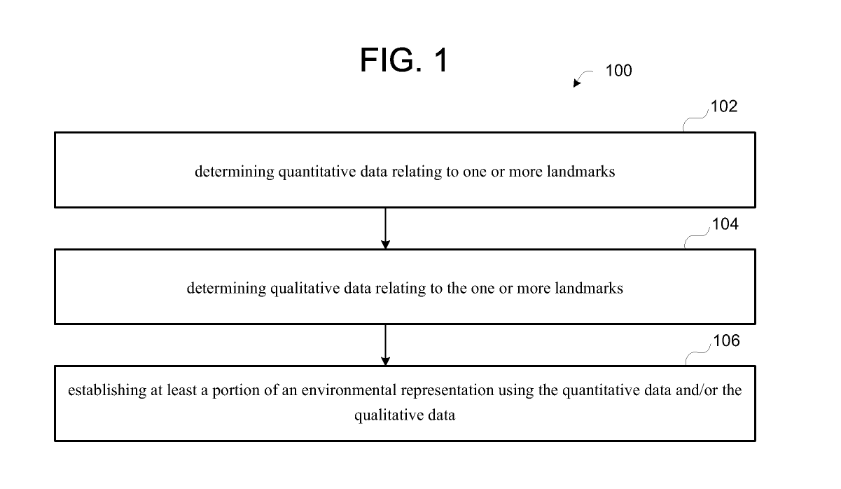

This invention relates generally to robotics, and more specifically, to systems and methods for establishing an environmental representation. Specific details of certain embodiments of the invention are set forth in the following description and in FIGS. 1-16 and Appendix A to provide a thorough understanding of such embodiments. The present invention may have additional embodiments, may be practiced without one or more of the details described for any particular described embodiment, or may have any detail described for one particular embodiment practiced with any other detail described for another embodiment.

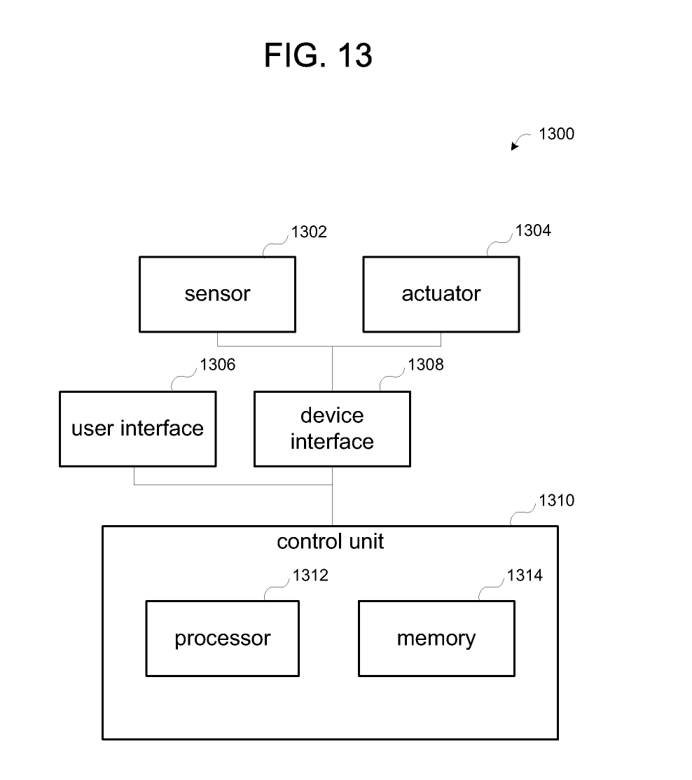

FIG. 13 is a component diagram of a system for establishing an environmental representation, in accordance with an embodiment of the invention. System 1300 or any of its components may be used to implement any embodiment of the invention disclosed herein. In some embodiments, system 1300 may include one or more sensors 1302, one or more actuators 1304, one or more user interfaces 1306, one or more device interfaces 1308, and one or more control units 1310. In some embodiments, one or more sensors 1302 may include a range sensor, a color sensor, a timing sensor, a motion sensor, a pressure sensor, an entity sensor, a light sensor, a laser sensor, an ultraviolet sensor, an acoustic sensor, an RFID sensor, a contact sensor, an imaging sensor such as a camera, video camera, or any other imaging sensor, an inertial sensor, and/or any other type of sensor. In some embodiments, one or more actuators 1304 may include any component for implementing or causing to implement any motion. In some embodiments, one or more user interfaces 1306 may include any electronic and/or mechanical components configured for communicating with and/or receiving communications from a user, such as keys, a display, cursor control, and/or any other means. In some embodiments, one or more device interfaces 1308 may include any electronic and/or mechanical components configured for communicating with and/or receiving communications from a device, such as via VGA, RS-232, 802.11b/g/n, HDMI, component video, USB, infrared, S-video, DVI-D, ethernet, cellular, wireless USB, bluetooth, and/or any other methodology. In some embodiments, one or more control units 1310 may include one or more processors 1312 and/or one or more memories 1314. In some embodiments, one or more processors 1312 may include any computer processor, which may include processor memory and/or logic. In some embodiments, one or more memories 1314 may include any volatile or non-volatile storage medium and/or logic.

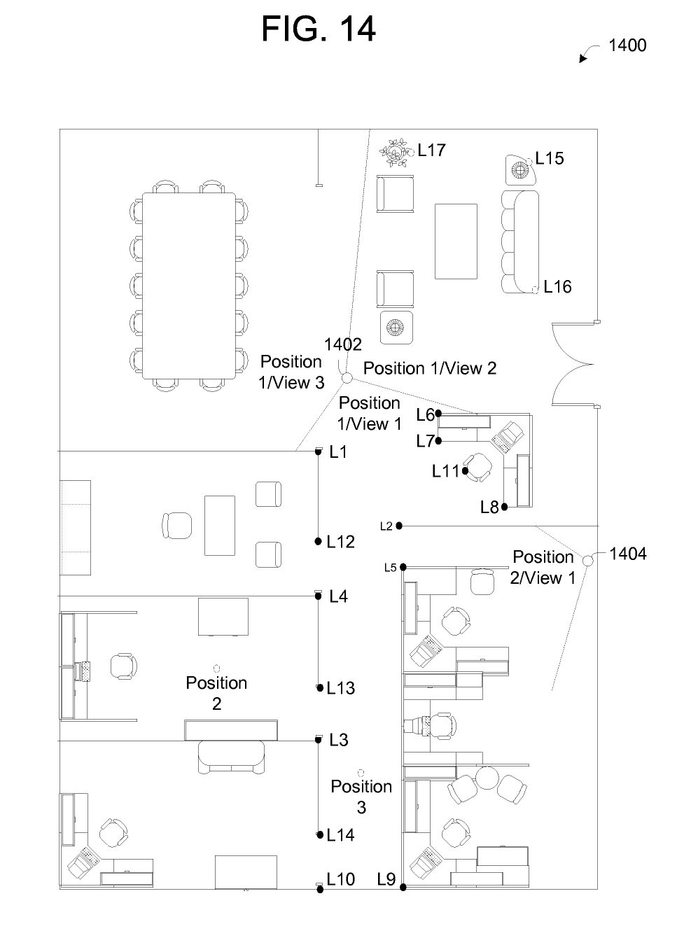

FIG. 14 is a plan diagram of a robot within an environment for establishing an environmental representation, in accordance with an embodiment of the invention. In some embodiments, diagram 1400 includes a robot 1402 and a robot 1404 positioned at position 1 and position 2, respectively, within an environment. The environment includes landmarks L1-L17. Various embodiments discussed herein will reference FIG. 14 to provide various non-limiting examples to assist with understanding principles of the invention. As such, many changes may be made to FIG. 14 without departing from the scope of the invention. For example, the environment may be commercial, industrial, or personal in nature and may be indoors or outdoors and may include natural or artificial components. Furthermore, the environment may be two or three dimensions or include a plurality of different linked environments (e.g. indoors and outdoors or various floors of a building). Moreover, only one robot 1402 may be provided or more than two robots 1402 and 1404 may be provided. Also, robots may be stationary, movable, or rotatable, such as to more than two positions or less or more than three views. Additionally, additional or fewer landmarks may be provided. For example, landmarks may range from one to thousands to millions or even more in number. Additionally, landmarks may be two dimensionally based, such as along a floor or ceiling, or three-dimensionally based, such as within different planes of the environment. Furthermore, each object in an environment may have one or two or more landmarks associated therewith, depending upon a desired level of precision. Many other changes will be apparent upon a review of the following description.

FIG. 1 is a block diagram of a method for establishing an environmental representation, in accordance with an embodiment of the invention. In some embodiments, method 100 may include operations of determining quantitative data relating to one or more landmarks at block 102; determining qualitative data relating to the one or more landmarks at block 104; and establishing at least a portion of an environmental representation using the quantitative data and/or the qualitative data at block 106.

In some embodiments, the operation of determining quantitative data relating to one or more landmarks at block 102 may be performed by one or more control units 1310. For example, the operation of determining quantitative data relating to one or more landmarks at block 102 may be performed by a device configured for association with machinery having one or more control units 1310. Alternatively, the operation of determining quantitative data relating to one or more landmarks at block 102 may be performed by a robot having one or more control units 1310. In some embodiments, determining quantitative data relating to one or more landmarks at block 102 may include determining a distance, angle, an existence of an opening, a height, a width, a length, a coordinate on a reference coordinate system, a GPS coordinate, and/or any other quantitative data relating to one or more landmarks. In some embodiments, determining quantitative data relating to one or more landmarks at block 102 may include determining quantitative data relating to a landmark being interior, exterior, artificial, natural, and/or of any other property.

In some embodiments, the operation of determining qualitative data relating to the one or more landmarks at block 104 may be performed by one or more control units 1310. For example, the operation of determining qualitative data relating to the one or more landmarks at block 104 may be performed by a device configured for association with machinery having one or more control units 1310. Alternatively, the operation of determining qualitative data relating to the one or more landmarks at block 104 may be performed by a robot having one or more control units 1310. In some embodiments, determining qualitative data relating to the one or more landmarks at block 104 may include determining a color, a texture, a shape, an odor, a sound, a flavor, a spatial relationship, a relative position relationship, an orientation, a surface pattern, and/or any other qualitative data relating to the one or more landmarks. In some embodiments, determining qualitative data relating to the one or more landmarks at block 104 may include determining qualitative data relating to a landmark being interior, exterior, artificial, natural, and/or of any other property.

In some embodiments, the operation of establishing at least a portion of an environmental representation using the quantitative data and/or the qualitative data at block 106 may be performed by one or more control units 1310. For example, the operation of establishing at least a portion of an environmental representation using the quantitative data and/or the qualitative data at block 106 may be performed by a device configured for association with machinery having one or more control units 1310. Alternatively, the operation of establishing at least a portion of an environmental representation using the quantitative data and/or the qualitative data at block 106 may be performed by a robot having one or more control units 1310. In some embodiments, establishing at least a portion of an environmental representation using the quantitative data and/or the qualitative data at block 106 may include establishing at least a portion of an environmental representation including the one or more landmarks associated with the quantitative data and/or the qualitative data determined for the one or more landmarks. In some embodiments, establishing at least a portion of an environmental representation using the quantitative data and/or the qualitative data at block 106 may include establishing an environmental representation of an internal, external, artificial, and/or natural environment using the quantitative data and/or the qualitative data.

Accordingly, in some embodiments, method 100 may be used to establish an environmental representation of a warehouse, an office space, a home, a boat, an airport, a school, a yard, a shopping center, a city, a state, a country, a marina, and/or any other environment including landmarks associated with quantitative and/or qualitative data. In some embodiments, an established environmental representation including landmarks associated with quantitative and/or qualitative data can be used for navigation and/or positional determinations within an environment. In some embodiments, an established environmental representation including landmarks associated with quantitative and/or qualitative data can be used for navigation and/or positional determinations within an environment independent of changes in scale, rotation, and/or displacement.

For example, FIG. 14 illustrates an office space whereby method 100 may be used to establish an environmental representation. The determining quantitative data relating to one or more landmarks at block 102 may include determining distances, positions, and angles relating to landmarks L1-L14 as illustrated in Table 1, wherein each landmark pair is associated with coordinates for the landmark pair, a distance between the landmark pair, an array of distances between all other landmarks with respect to the landmark pair, and an array of angles with all other landmarks with respect to the landmark pair. For example, the landmark pair L1-L2 may be associated with coordinates of L1, coordinates of L2, a distance between L1 and L2, an array of distances between L1 and all landmarks L3-L14, an array of distances between L2 and all landmarks L3-L14, an array of angles at L1 with L2 and all other landmarks L3-L14, and an array of angles at L2 with L1 and all other landmarks L3-11.

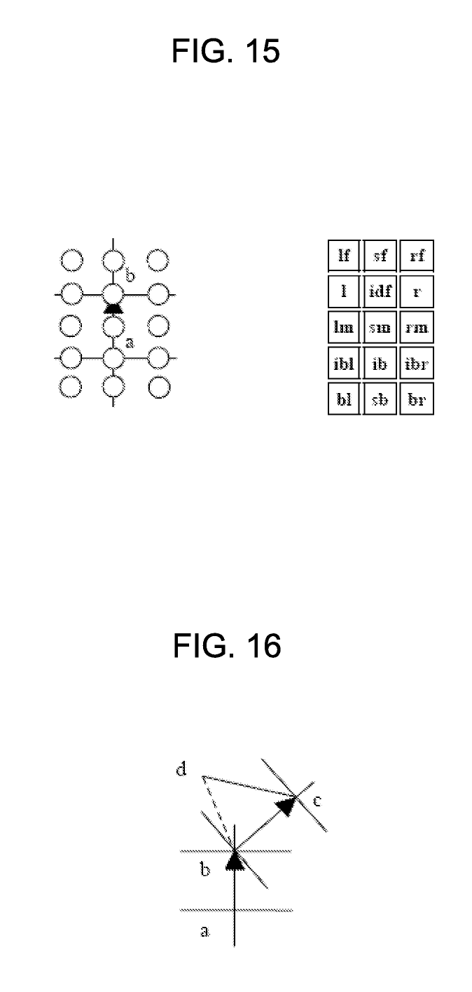

The determining qualitative data relating to the one or more landmarks at block 104 may include determining colors, shapes, odors, sounds, surface patterns, and orientations relating to landmarks L1-L14 as illustrated in Table 1, wherein each landmark pair is associated with colors of the landmark pair, shapes of the landmark pair, odors of the landmark pair, sounds of the landmark pair, surface patterns of the landmark pair, and an array of orientation of all other landmarks with respect to the landmark pair. For example, the landmark pair L1-L2 may be associated with colors of or around L2 sensed from L1, colors of or around L1 sensed from L2, shapes of or around L2 sensed 205 from L1, shapes of or around L1 sensed from L2, odors of or around L2 sensed from L1, odors of or around L1 sensed from L2, sounds of or around L2 sensed from L1, sounds of or around L1 sensed from L2, surface patterns of or around L2 sensed from L1, surface patters of or around L1 sensed from L2, an array of orientations of all other landmarks L3-11 as sensed from L1 aligned with L2, and an array of orientations of all other landmarks L3-11 as sensed from L2 aligned with L1. FIG. 15 illustrates an example field arrangement relative to two landmarks a and b, which field arrangement may be employed for describing the orientations of all other landmarks with respect to a landmark pair. The field arrangement illustrated includes a landmark pair surrounded by fields described as left front, straight front, right front, left, immediate front, right, left middle, straight middle, right middle, immediate back left, immediate back, immediate back right, back left, straight back, and back right. Other landmarks can therefore be described relative to their field position.

TABLE 1

| | L1 | L2 | . . . | L14 |
|---|---|---|---|---|
| L1 | | L1-L2 | L1-Ly | L1-L14 |
| L2 | L2-L1 | L2-L2 | L2-Ly | L2-L14 |
| . . . | Lx-L1 | Lx-L2 | Lx-Ly | Lx-L14 |
| L14 | L14-L1 | L14-L2 | L14-Ly | |

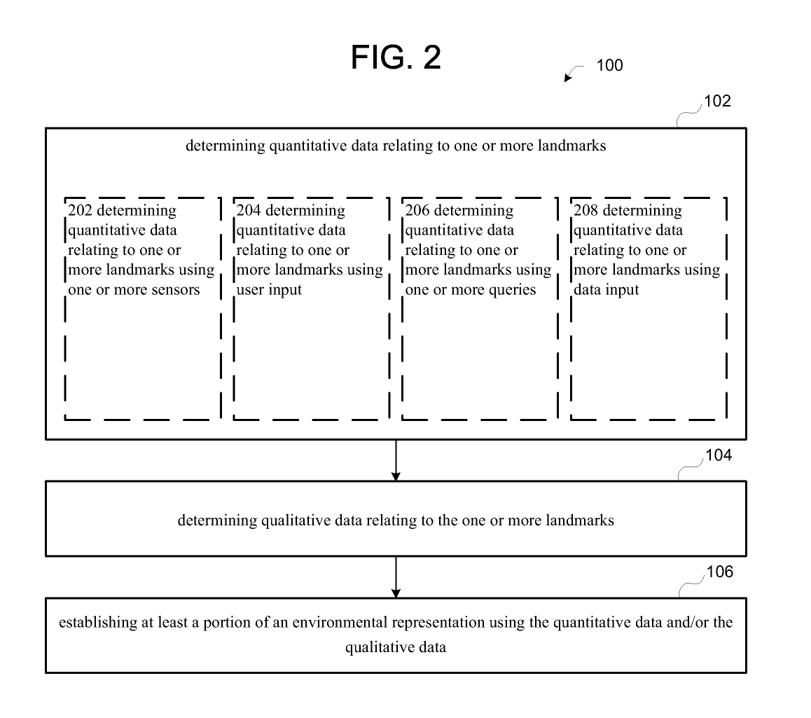

FIG. 2 is a block diagram of various embodiments of a method for establishing an environmental representation, in accordance with various embodiments of the invention. In some embodiments, method 100 may include one or more alternative operations of determining quantitative data relating to one or more landmarks using one or more sensors at block 202; determining quantitative data relating to one or more landmarks using user input at block 204; determining quantitative data relating to one or more landmarks using one or more queries at block 206; and/or determining quantitative data relating to one or more landmarks using data input at block 208.

In some embodiments, determining quantitative data relating to one or more landmarks using one or more sensors at block 202 may be performed by one or more control units 1310 using one or more sensors 1302. For example, the operation of determining quantitative data relating to one or more landmarks using one or more sensors at block 202 may be performed by a device configured for association with machinery having one or more control units 1310 using one or more sensors 1302. Alternatively, the operation of determining quantitative data relating to one or more landmarks using one or more sensors at block 202 may be performed by a robot having one or more control units 1310 using one or more sensors 1302. In some embodiments, determining quantitative data relating to one or more landmarks using one or more sensors at block 202 may include determining quantitative data relating to one or more landmarks using one or more distance, angle, presence, and/or other sensors. In some embodiments, determining quantitative data relating to one or more landmarks using one or more sensors at block 202 may include determining quantitative data relating to one or more landmarks using one or more movable or stationary sensors. In some embodiments, determining quantitative data relating to one or more landmarks using one or more sensors at block 202 may include determining quantitative data relating to one or more landmarks using one or more on-board and/or off-board positioned sensors. For example, a robot 1402 as illustrated in FIG. 14 may have on-board sensors or sensors may be off-board and positioned in various places in the office space environment. In some embodiments, determining quantitative data relating to one or more landmarks using one or more sensors at block 202 may include determining quantitative data relating to one or more landmarks using one or more sensors at a series of positions. For example, in one particular embodiment, a robot having sensors may move through an environment to determine quantitative data relating to landmarks in the environment using its sensors. For example, a robot 1402 having sensors may move through an office space environment as illustrated in FIG. 14 to determine quantitative data relating to landmarks L1-L14 and all other unlabeled landmarks in the office space environment using its sensors. Robot 1402 is illustrated as having a view of landmarks L1-L14 at V1, but robot 1402 may rotate and/or move for different views of similar or different landmarks.

In some embodiments, determining quantitative data relating to one or more landmarks using user input at block 204 may be performed by one or more control units 1310 using one or more user interfaces 1306. For example, the operation of determining quantitative data relating to one or more landmarks using user input at block 204 may be performed by a device configured for association with machinery having one or more control units 1310 using one or more user interfaces 1306. Alternatively, the operation of determining quantitative data relating to one or more landmarks using user input at block 204 may be performed by a robot having one or more control units 1310 using one or more user interfaces 1306. In some embodiments, determining quantitative data relating to one or more landmarks using user input at block 204 may include determining quantitative data relating to one or more landmarks using data entry, menu selection, audible instruction, motion indication, physical guidance, and/or other user input. For example, robot 1402 may determine quantitative data relating to landmarks L1-L14 using motion guidance to identify the landmarks L1-L14. In some embodiments, determining quantitative data relating to one or more landmarks using user input at block 204 may include determining quantitative data relating to one or more landmarks using user input provided locally and/or remotely via manual, electronic, and/or wireless communication. For example, robot 1402 may determine quantitative data relating to landmarks L1-L14 using user input provided through a mobile computing device to identify the landmarks from images viewed or captured by the robot 1402. In some embodiments, determining quantitative data relating to one or more landmarks using user input at block 204 may include determining quantitative data relating to one or more landmarks using user input to verify any determined quantitative data. For example, in one particular embodiment, a robot may determine quantitative data relating to landmarks in an environment upon a user identifying landmarks through a hand movement gesture.

In some embodiments, determining quantitative data relating to one or more landmarks using one or more queries at block 206 may be performed by one or more control units 1310 using one or more device interfaces 1308. For example, the operation of determining quantitative data relating to one or more landmarks using one or more queries at block 206 may be performed by a device configured for association with machinery having one or more control units 1310 using one or more device interfaces 1308. Alternatively, the operation of determining quantitative data relating to one or more landmarks using one or more queries at block 206 may be performed by a robot having one or more control units 1310 using one or more device interfaces 1308. In some embodiments, determining quantitative data relating to one or more landmarks using one or more queries at block 206 may include determining quantitative data relating to one or more landmarks using one or more queries of a data source. For example, robot 1402 may determine quantitative data relating to landmarks L1-L14 using queries of a floor plan data file, such as to determine existence of landmarks L1-L14 in the floor plan data file. In some embodiments, determining quantitative data relating to one or more landmarks using one or more queries at block 206 may include determining quantitative data relating to one or more landmarks using one or more local and/or remote queries performed via electronic and/or wireless communication. For example, robot 1402 may determine quantitative data relating to landmarks L1-L14 using queries of a data file uploaded to the robot 1402 or using queries of a data file present on a network location or internet location. In some embodiments, determining quantitative data relating to one or more landmarks using one or more queries at block 206 may include determining quantitative data relating to one or more landmarks using one or more queries to verify any determined quantitative data. For example, in one particular embodiment, a robot may determine quantitative data relating to landmarks in an environment using one or more queries of an image or plan, construction, and/or architectural diagram. As an additional example, robot 1402 may determine quantitative data relating to landmarks L1-L14 using queries of another robot to confirm the existence of landmarks L1-L14. For example, landmark L14 may be determined not be a suitable landmark because of movement in the landmark L14 (i.e. due to movement of the chair associated with landmark L14).

In some embodiments, determining quantitative data relating to one or more landmarks using data input at block 208 may be performed by one or more control units 1310 using one or more device interfaces 1308. For example, the operation of determining quantitative data relating to one or more landmarks using data input at block 208 may be performed by a device configured for association with machinery having one or more control units 1310 using one or more device interfaces 1308. Alternatively, the operation of determining quantitative data relating to one or more landmarks using data input at block 208 may be performed by a robot having one or more control units 1310 using one or more device interfaces 1308. In some embodiments, determining quantitative data relating to one or more landmarks using data input at block 208 may include determining quantitative data relating to one or more landmarks by downloading previously determined quantitative data. For example, robot 1402 may determine quantitative data relating to landmarks L1-L14 by downloading previously determined quantitative data from another robot. For example, robot 1402 may be a cleaning robot and another robot for watering plants or some other function may already be in the office space environment from which robot 1402 can obtain previously determined quantitative data. In some embodiments, determining quantitative data relating to one or more landmarks using data input at block 208 may include determining quantitative data relating to one or more landmarks using data input received locally and/or remotely via electronic and/or wireless communication. For example, robot 1402 may determine quantitative data relating to landmarks L1-L14 using data input received from a service provider remotely located which service provider assists in setting up and/or maintaining robot 1402. In some embodiments, determining quantitative data relating to one or more landmarks using data input at block 208 may include determining quantitative data relating to one or more landmarks by receiving data input from another device and/or robot assisting with or dedicated to determining quantitative data. For example, robot 1402 may determine quantitative data relating to landmarks L1-L14 on its own and also determine quantitative data relating to other landmarks using input from another robot which robot itself may determine quantitative data relating to the other landmarks. Accordingly, a plurality of robots may be employed to determine quantitative data relating to landmarks more efficiently. In some embodiments, determining quantitative data relating to one or more landmarks using data input at block 208 may include determining quantitative data relating to one or more landmarks by receiving satellite positional information. For example, robot 1402 may determine coordinates of itself and/or landmarks L1-L14 using GPS. In some embodiments, determining quantitative data relating to one or more landmarks using data input at block 208 may include determining quantitative data relating to one or more landmarks by identifying RFID tags. For example, robot 1402 may determine quantitative data relating to landmarks L1-L14 by sensing a presence of an RFID tag placed in the office space environment, such as by a human or another robot. For example, in one particular embodiment, a robot may determine quantitative data relating to landmarks in an environment using data input from a collection of associate robots assisting with collection of quantitative data. Alternatively, in a further particular embodiment, a robot may determine quantitative data relating to landmarks in an environment using a series of GPS positions obtained from a satellite.

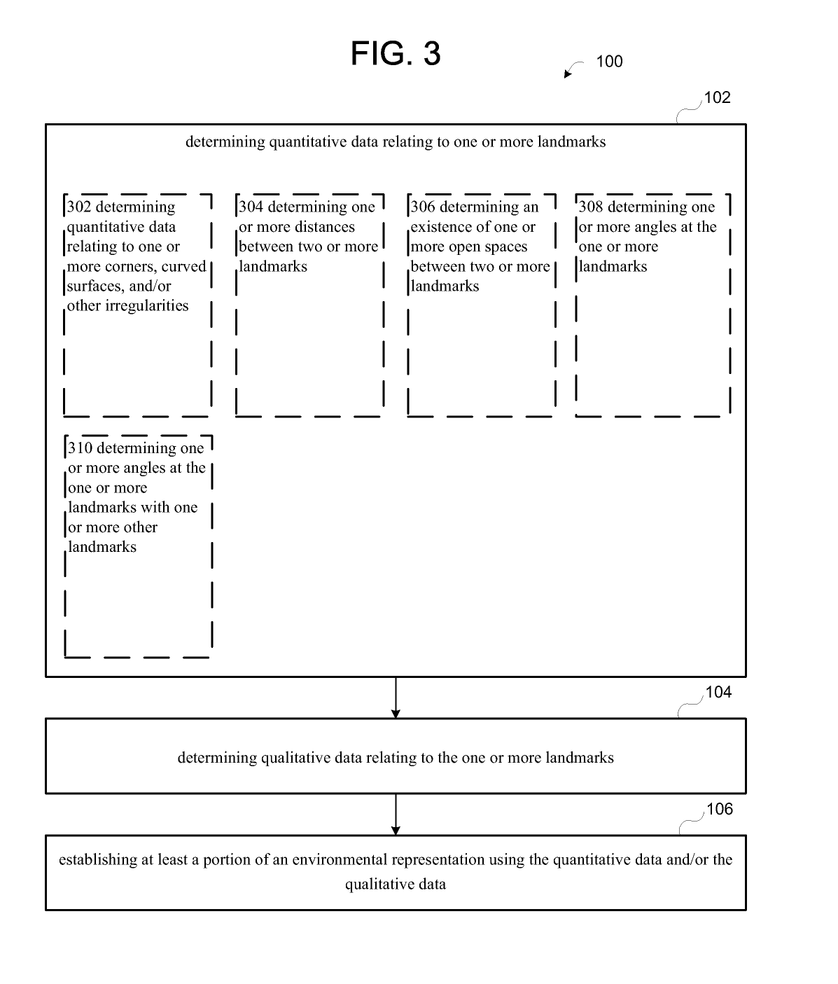

FIG. 3 is a block diagram of various embodiments of a method for establishing an environmental representation, in accordance with various embodiments of the invention. In some embodiments, method 100 may include one or more alternative operations of determining quantitative data relating to one or more corners, curved surfaces, and/or other irregularities at block 302; determining one or more distances between two or more landmarks at block 304; determining an existence of one or more open spaces between two or more landmarks at block 306; determining one or more angles at the one or more landmarks at block 308; and/or determining one or more angles at the one or more landmarks with one or more other landmarks at block 310.

In some embodiments, the operation of determining quantitative data relating to one or more corners, curved surfaces, and/or other irregularities at block 302 may be performed by one or more control units 1310. For example, the operation of determining quantitative data relating to one or more corners, curved surfaces, and/or other irregularities at block 302 may be performed by a device configured for association with machinery having one or more control units 1310. Alternatively, the operation of determining quantitative data relating to one or more corners, curved surfaces, and/or other irregularities at block 302 may be performed by a robot having one or more control units 1310. In some embodiments, determining quantitative data relating to one or more corners, curved surfaces, and/or other irregularities at block 302 may include determining quantitative data relating to one or more corners associated with a wall, door, ceiling, stair, floor, curb, post, fence, and/or other indoor or outdoor artificial and/or natural corner or disruption to continuity. For example, robot 1402 may determine quantitative data relating to landmarks L15 or L16 or to landmark L2 or to landmark L5 or any other corner, curved surface, other irregularity, and/or other disruption to continuity. In some embodiments, determining quantitative data relating to one or more corners, curved surfaces, and/or other irregularities at block 302 may include determining quantitative data relating to one or more indoor and/or outdoor artificial and/or natural curved surfaces. For example, robot 1402 may determine quantitative data relating to landmarks within the office space environment and also move outside to a parking lot or any other environment and determine quantitative data relating to landmarks in the parking lot. In some embodiments, determining quantitative data relating to one or more corners, curved surfaces, and/or other irregularities at block 302 may include determining quantitative data relating to one or more irregularities associated with a window, an outlet, a fixture, a picture/painting/print frame, furniture, a shelf, a crate, a floor panel, a drain, a plant, an architectural monument, a bench, a tree, a lamp post, a road, a sign, a bush, a pond, a structure, and/or other indoor or outdoor artificial and/or natural irregularity. For example, in one particular embodiment, a robot may determine quantitative data relating to substantially all room corners, doors, immovable objects, and/or windows of a commercial and/or residential building. Alternatively, a robot may determine quantitative data relating to substantially all trees, fences, bushes, stumps, structures, and/or obstructions of a lawn. Landmarks may be defined at various levels of specificity. For example, landmarks may include a building or windows on a building or walls within a building, or offices within a building, or furniture within a building or corners of furniture within a building or even more levels of specificity, such as down to a molecular or atomic level.

In some embodiments, the operation of determining one or more distances between two or more landmarks at block 304 may be performed by one or more control units 1310. For example, the operation of determining one or more distances between two or more landmarks at block 304 may be performed by a device configured for association with machinery having one or more control units 1310. Alternatively, the operation of determining one or more distances between two or more landmarks at block 304 may be performed by a robot having one or more control units 1310. In some embodiments, determining one or more distances between two or more landmarks at block 304 may include determining one or more distances between two or more adjacent, proximate, and/or remote landmarks. For example, robot 1402 may determine distances between landmarks L1 and L2-L14; between landmarks L2 and L1, L3-L14; between landmarks L3 and L1-L2, L4-L14; and remaining distances between landmarks L1-L14. In some embodiments, determining one or more distances between two or more landmarks at block 304 may include determining one or more distances between two or more similar and/or distinct landmarks. For example, robot 1402 may determine distances between similar landmarks L12 and L4 (e.g. opposing door frames) and/or distances between different landmarks L5 and L2 (e.g. an outside corner and a wall end). In some embodiments, determining one or more distances between two or more landmarks at block 304 may include determining one or more direct and/or travel distances between two or more landmarks. For example, robot 1402 may determine a direct distance between landmarks L14 and L11 (e.g. distance from L14 to L11 through walls) and/or a travel distance between L14 and L11 (e.g. distance via walkways). For example, in one particular embodiment, a robot may determine a distance between opposing sides of a doorway, a distance between room corners, a distance between a floor and ceiling, a distance between a bottom and top of a stair, a distance between opposing room corners, and/or a distance of travel between a first entryway to a second entryway in a commercial and/or residential building.

In some embodiments, the operation of determining an existence of one or more open spaces between two or more landmarks at block 306 may be performed by one or more control units 1310. For example, the operation of determining an existence of one or more open spaces between two or more landmarks at block 306 may be performed by a device configured for association with machinery having one or more control units 1310. Alternatively, the operation of determining an existence of one or more open spaces between two or more landmarks at block 306 may be performed by a robot having one or more control units 1310. In some embodiments, determining an existence of one or more open spaces between two or more landmarks at block 306 may include determining an existence of one or more open spaces between similar and/or different landmarks. For example, robot 1402 may determine an existence of an open space between different landmarks L12 and L2 and/or may determine an existence of an open space between similar landmarks L3 and L13. In some embodiments, determining an existence of one or more open spaces between two or more landmarks at block 306 may include determining an existence of one or more open spaces in two and/or three dimensions. For example, a robot 1402 may determine an existence of an open space in two dimensions between landmarks L12 and L4 and/or determine an existence of an open space in three dimensions between landmarks L12 and L4 (e.g. a width and height of an open space as opposed to just an open space at floor level which can assist in determining clearance levels for certain operations). Additionally, a robot 1402 may determine an existence of an open space in three dimensions between landmarks of a window or other wall or ceiling opening (not labeled). In some embodiments, determining an existence of one or more open spaces between two or more landmarks at block 306 may include determining an existence of one or more open spaces between wall corners, doorway sides, window sills, railings, ceiling corners, floor corners, and/or other indoor and/or outdoor artificial and/or natural landmarks. For example, robot 1402 may determine an existence of an open space between landmarks L7 and L8 (e.g. under desk) and/or between landmarks L17 and L15 (e.g. between plant and side table). In some embodiments, determining an existence of one or more open spaces between two or more landmarks at block 306 may include determining an existence of one or more open spaces between a bush and a tree, a fence and a pond, a stump and curb, a garbage bag and a parked vehicle, and/or other indoor and/or outdoor artificial and/or natural landmarks. For example, robot 1402 may be transported to a shipping yard area and may determine an existence of an open space between shipping containers, a truck and a pallet, or any other landmark. For example, in one particular embodiment, a robot may determine an existence of an open space for purposes of cleaning, mowing, transporting, moving, and/or other indoor and/or outdoor commercial and/or personal activity. Additionally, in other embodiments, a robot may determine an existence of an open space for purposes of establishing an environmental representation available to one or more other robots having specialized functions.

In some embodiments, the operation of determining one or more angles at the one or more landmarks at block 308 may be performed by one or more control units 1310. For example, the operation of determining one or more angles at the one or more landmarks at block 308 may be performed by a device configured for association with machinery having one or more control units 1310. Alternatively, the operation of determining one or more angles at the one or more landmarks at block 308 may be performed by a robot having one or more control units 1310. In some embodiments, determining one or more angles at the one or more landmarks at block 308 may include determining one or more horizontal, vertical, rotational, and/or other angles at the one or more landmarks. For example, robot 1402 may determine a corner angle of landmark L1 or a surface curvature of landmark L15. For example, in one particular embodiment, a robot may determine an angle of an inward wall corner, an outward wall corner, a floor corner, a yard boundary, a road peak, a surface slope, a surface peak, a surface depression, a surface curvature, and/or other indoor and/or outdoor artificial and/or natural landmark.

In some embodiments, the operation of determining one or more angles at the one or more landmarks with one or more other landmarks at block 310 may be performed by one or more control units 1310. For example, the operation of determining one or more angles at the one or more landmarks with one or more other landmarks at block 310 may be performed by a device configured for association with machinery having one or more control units 1310. Alternatively, the operation of determining one or more angles at the one or more landmarks with one or more other landmarks at block 310 may be performed by a robot having one or more control units 1310. In some embodiments, determining one or more angles at the one or more landmarks with one or more other landmarks at block 310 may include determining one or more horizontal, vertical, rotational and/or other angles at the one or more landmarks with one or more other landmarks. For example, robot 1402 may determine horizontal angles of landmarks L1 with L2 and L3-L14; horizontal angles of landmarks L2 with L1 and L3-L14; and remaining horizontal angles of landmarks L1-L14. As an additional example, robot 1402 may determine a vertical angle of L12 with L4 and the door frame corner above L4 (not visible). In some embodiments, determining one or more angles at the one or more landmarks with one or more other landmarks at block 310 may include determining one or more angles at the one or more landmarks with one or more other similar and/or different landmarks. For example, robot 1402 may determine angles at landmark L5 with landmarks L9 and L14 (e.g. on outside corner, an inside corner, and door frame, respectively). In some embodiments, determining one or more angles at the one or more landmarks with one or more other landmarks at block 310 may include determining one or more angles at the one or more landmarks with one or more other adjacent, proximate, and/or remote landmarks. For example, robot 1402 may determine an angle at L1 with L6 and another landmark in another office or outside (e.g. such as a designated reference landmark). For example, in one particular embodiment, a robot may determine an angle between adjacent wall corners, opposing wall corners, a wall corner and a shelf, a wall corner and a window sill, a wall corner and an outlet, a wall corner and a doorway side, a wall corner and a barrier, a property corner and a structure, a property corner and a tree, a property corner and a well, a property corner and a post, and/or other indoor and/or outdoor artificial and/or natural landmarks.

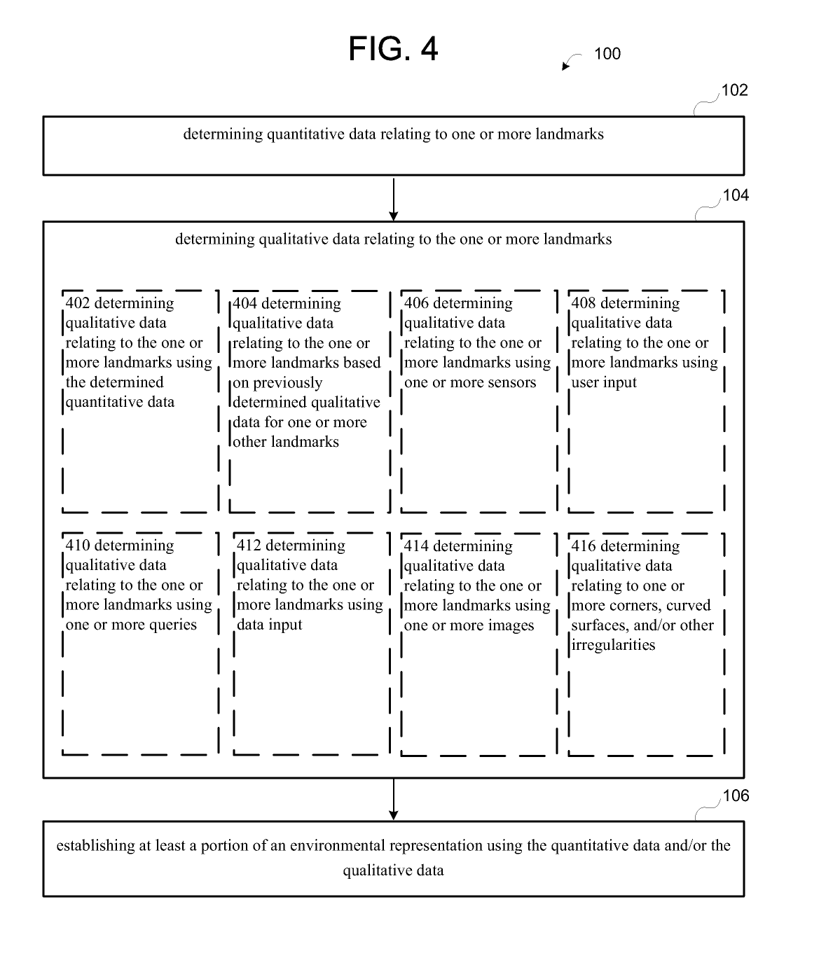

FIG. 4 is a block diagram of various embodiments of a method for establishing an environmental representation, in accordance with various embodiments of the invention. In some embodiments, method 100 may include one or more alternative operations of determining qualitative data relating to the one or more landmarks using the determined quantitative data at block 402; determining qualitative data relating to the one or more landmarks based on previously determined qualitative data for one or more other landmarks at block 404; determining qualitative data relating to the one or more landmarks using one or more sensors at block 406; determining qualitative data relating to the one or more landmarks using user input at block 408; determining qualitative data relating to the one or more landmarks using one or more queries at block 410; determining qualitative data relating to the one or more landmarks using data input at block 412; determining qualitative data relating to the one or more landmarks using one or more images at block 414; determining qualitative data relating to one or more corners, curved surfaces, and/or other irregularities at block 416.

In some embodiments, the operation of determining qualitative data relating to the one or more landmarks using the determined quantitative data at block 402 may be performed by one or more control units 1310. For example, the operation of determining qualitative data relating to the one or more landmarks using the determined quantitative data at block 402 may be performed by a device configured for association with machinery having one or more control units 1310. Alternatively, the operation of determining qualitative data relating to the one or more landmarks using the determined quantitative data at block 402 may be performed by a robot having one or more control units 1310. In some embodiments, determining qualitative data relating to the one or more landmarks using the determined quantitative data at block 402 may include determining a representation of spatial surroundings relating to the one or more landmarks using the determined quantitative data. In some embodiments, determining qualitative data relating to the one or more landmarks using the determined quantitative data at block 402 may include determining a visual representation relating to the one or more landmarks using the determined quantitative data. For example, robot 1402 may use the field arrangement of FIG. 15 and the positions, distances, and angles determined for landmarks to provide visual representations of landmark L2 with respect to landmarks L1 and L12 and with respect to L12 and L1; visual representations of landmark L12 with respect to landmarks L5 and L4 and with respect to L4 and L5; visual representations of landmark L1 with respect to landmarks L9 and L5 and L5 and L9; and visual representations of remaining landmarks L1-L14. The visual representation may include field shading to indicate a presence of a landmark within the field arrangement. Alternatively, robot 1402 may use the field arrangement of FIG. 15 and the positions, distances, and angles determined for landmarks to provide a descriptive representation of the landmarks (e.g. L2 with respect to L5 and L12 may be associated with “rm” or right middle). Additionally, in some embodiments, determining qualitative data relating to the one or more landmarks may include determining a three-dimensional visual representation relating to the one or more landmarks (e.g. a three-dimensional version of the field arrangement illustrated in FIG. 15). In some embodiments, determining qualitative data relating to the one or more landmarks using the determined quantitative data at block 402 may include determining qualitative data relating to the one or more landmarks using one or more distances, angles, existences of open spaces, and/or other determined quantitative data. For example, robot 1402 may determine a position of landmark L2 with respect to landmarks L5 and L12 using a distance between L5 and L12, a distance between L5 and L2, a distance between L12 and L2, an angle at L5 with L12 and L2, an angle at L12 with L2 and L5, an angle at L2 with L5 and L12, a determined open space between L2 and L5, a determined open space between L5 and L12, a determined open space between L12 and L2, and any other determined quantitative data. For example, in one particular embodiment, a robot may determine a representation of spatial surroundings relating to a wall corner and/or perspective, wherein the representation of spatial surroundings may indicate positions of one or more corners, curved surfaces, irregularities, and/or other landmarks in regions around the wall corner and/or perspective. Alternatively, in another particular embodiment, a robot may determine a visual representation relating to a landmark, wherein the visual representation may indicate a view of the landmark from one or more landmarks and/or perspectives. For example, robot 1402 may reconstruct a visual representation of landmark L2 from landmark L4 using determined distances between L4 and L5, L12, L2, L6, and L7; determined angles at L4, L5, L12, L2, L6, and L7 with other landmarks; determined heights of L5, L12, L2, L6, L7; determined existences of open spaces between L4, L5, L2, L12, L6, and L7 with other landmarks; and any other determined quantitative data, such as to supplement or clarify a visual representation of L2 obtained using a camera.

In some embodiments, the operation of determining qualitative data relating to the one or more landmarks based on previously determined qualitative data for one or more other landmarks at block 404 may be performed by one or more control units 1310. For example, the operation of determining qualitative data relating to the one or more landmarks based on previously determined qualitative data for one or more other landmarks at block 404 may be performed by a device configured for association with machinery having one or more control units 1310. Alternatively, the operation of determining qualitative data relating to the one or more landmarks based on previously determined qualitative data for one or more other landmarks at block 404 may be performed by a robot having one or more control units 1310. In some embodiments, determining qualitative data relating to the one or more landmarks based on previously determined qualitative data for one or more other landmarks at block 404 may include determining a representation of spatial surroundings relating to the one or more landmarks based on previously determined qualitative data for one or more other landmarks. For example, FIG. 16 illustrates determining a representation of spatial surroundings of landmark d with respect to landmarks a and b based upon previously determined representations of spatial surroundings of landmark c with respect to landmarks a and b and of landmark d with respect to landmarks b and c. That is, knowing representations of spatial surroundings of c with respect to a and b and of d with respect to b and c, it is possible to determine a representation of spatial surroundings of d with respect to a and b without necessarily requiring other information. That is, for example, upon knowing a qualitative relationship (i.e. orientation, position, distance, or other similar relationship) of object c with respect to a reference system formed by objects a and b and upon knowing a qualitative relationship (i.e. orientation, position, distance, or other similar relationship) of object d with respect to a reference system formed by the objects b and c, it is possible to determine a qualitative relationship (i.e. orientation, position, distance, or other similar relationship) between object d with respect to the reference system formed by objects a and b. In one embodiment, this may be referred to as a basic step of the inference process. Furthermore, for example, when more than four objects are present, it is possible to repeat the basic step of the inference process until no further information can be determined from original information and/or inferred information. This may be referred to as a complete inference process. In certain embodiments, information may be stored in a map, wherein the may contains qualitative relationships of any kind between any object with respect to any other pair of objects. Accordingly, in one embodiment, when a robot identifies any pair of objects (i.e. landmarks in an environment), the robot may be able to determine a position, orientation, distance of any other object. Thus, for example, robot 1402 may determine a representation of spatial surroundings of landmark L1 with respect to L5 and L12 based on previously determined representations of spatial surroundings of landmark L2 with respect to landmarks L5 and L12 and of landmark L1 with respect to landmarks L12 and L2. In some embodiments, determining qualitative data relating to the one or more landmarks based on previously determined qualitative data for one or more other landmarks at block 404 may include determining a visual representation relating to the one or more landmarks based on previously determined qualitative data for one or more other landmarks. For example, robot 1402 may determine a visual representation of L1 from L5 based on previously determined visual representations of L12 from L5 and L1 from L12. In some embodiments, determining qualitative data relating to the one or more landmarks based on previously determined qualitative data for one or more other landmarks at block 404 may include determining qualitative data relating to the one or more landmarks based on one or more previously determined spatial representations, visual representations, and/or other qualitative data for one or more other landmarks. For example, in one particular embodiment, a robot may determine a representation of spatial surroundings relating to a wall corner and/or perspective, wherein the representation of spatial surroundings may indicate positions of one or more corners, curved surfaces, irregularities, and/or other landmarks in fields around the wall corner and/or perspective, based on a representation of spatial surroundings relating to a proximate doorway side, opposing wall corner, other landmark, and/or another perspective. Alternatively, in another particular embodiment, a robot may determine a visual representation relating to an irregularity, wherein the visual representation may indicate a view of the irregularity from one or more landmarks and/or perspectives, based on a visual representation of the irregularity from another landmark and/or perspective.

In some embodiments, the operation of determining qualitative data relating to the one or more landmarks using one or more sensors at block 406 may be performed by one or more control units 1310 using one or more sensors 1302. For example, the operation of determining qualitative data relating to the one or more landmarks using one or more sensors at block 406 may be performed by a device configured for association with machinery having one or more control units 1310 using one or more sensors 1302. Alternatively, the operation of determining qualitative data relating to the one or more landmarks using one or more sensors at block 406 may be performed by a robot having one or more control units 1310 using one or more sensors 1302. In some embodiments, determining qualitative data relating to the one or more landmarks using one or more sensors at block 406 may include determining qualitative data relating to the one or more landmarks using one or more distance, angle, presence, image, color, entity, odor, sound, light, contact, flavor, motion, and/or other sensors. For example, robot 1402 may determine odor data relating to landmark L8 by using an odor sensor (e.g. to detect a fragrance of a person typically sitting near landmark L8 or to detect a food odor from a garbage can near landmark L8). Alternatively, for example, robot 1402 may determine sound data relating to landmark L8 by using a sound sensor (e.g. to detect a typing sound from a keyboard near landmark L8 or to detect a door opening/closing near landmark L8). Additionally, for example, robot 1402 may determine light intensity data relating to landmark L8 by using a light sensor (e.g. to detect a low light intensity level at landmark L8). Further, for example, robot 1402 may determine motion level data relating to landmark L6 by using a motion sensor (e.g. to detect high motion levels perhaps due to foot traffic near landmark L6). In some embodiments, determining qualitative data relating to the one or more landmarks using one or more sensors at block 406 may include determining qualitative data relating to the one or more landmarks using one or more on-board or off-board movable or stationary sensors. For example, robot 1402 may determine qualitative data relating to landmarks L1-L14 using an on-board sensor that is positionally fixed or that is rotatable or gyratable. Robot 1402 may also determine qualitative data relating to landmarks L1-L14 using one or more sensors that may be fixedly or movably mounted in the environment, transported through the environment (e.g. a handheld sensor), or fixedly or movably coupled to another robot. The sensors may transmit information via hardwire or wireless communication. In some embodiments, determining qualitative data relating to the one or more landmarks using one or more sensors at block 406 may include determining qualitative data relating to the one or more landmarks using one or more locally and/or remotely positioned sensors. In some embodiments, determining qualitative data relating to the one or more landmarks using one or more sensors at block 406 may include determining qualitative data relating to the one or more landmarks using one or more sensors at a series of positions. For example, in one particular embodiment, a robot having sensors may move through an environment to determine qualitative data relating to landmarks in the environment using its sensors. For example, robot 1402 may move to different positions within the environment, such as position 1, position 2, position 3, and other positions, to determine qualitative data relating to landmarks L1-L14.

In some embodiments, the operation of determining qualitative data relating to the one or more landmarks using user input at block 408 may be performed by one or more control units 1310 using one or more user interfaces 1306. For example, the operation of determining qualitative data relating to the one or more landmarks using user input at block 408 may be performed by a device configured for association with machinery having one or more control units 1310 using one or more user interfaces 1306. Alternatively, the operation of determining qualitative data relating to the one or more landmarks using user input at block 408 may be performed by a robot having one or more control units 1310 using one or more user interfaces 1306. In some embodiments, determining qualitative data relating to the one or more landmarks using user input at block 408 may include determining qualitative data relating to the one or more landmarks using data entry, menu selection, audible instruction, motion indication, physical guidance, and/or other user input. For example, robot 1402 may determine qualitative data for one of the landmarks L1-L14 upon detecting a hand motion proximate to the landmark. Also, for example, robot 1402 may determine qualitative data for one of the landmarks L1-L14 upon receiving an audible instruction indicating coordinates of the landmark, a type of landmark (e.g. all inside corners, all wall ends, all windows, or all doors). Additionally, robot 1402 may determine qualitative data for one of the landmarks L1-L14 at least partially using data entry, such as to provide, supplement, or correct landmark identifications, types of qualitative data (e.g. colors, sounds, and shapes for certain landmarks and visual or spatial representations for other landmarks), or values of qualitative data. In some embodiments, determining qualitative data relating to the one or more landmarks using user input at block 408 may include determining qualitative data relating to the one or more landmarks using user input provided locally and/or remotely via manual, electronic, and/or wireless communication. For example, robot 1402 may be controllable from a remote computing device and may determine qualitative data relating to the landmarks L1-L14 using input provided using the remote computing device (e.g. user input that identifies landmarks, selects a type of qualitative data to be determined for landmarks, or identifies confusing or incomplete determined qualitative data). In some embodiments, determining qualitative data relating to the one or more landmarks using user input at block 408 may include determining qualitative data relating to the one or more landmarks using user input to verify any determined qualitative data. For example, robot 1402 may determine qualitative data and present the same for independent review of identified landmarks, types of qualitative data determined for the identified landmarks, and value of qualitative data determined for the identified landmarks, wherein user input may be received to approve, reject, modify, or enhance the determined qualitative data. Such user input may be provided electronically or wirelessly and via real time or batch processing. For example, in one particular embodiment, a robot may determine qualitative data relating to landmarks in an environment through a combination of automatically determined qualitative data, data entry, and/or user verification.

In some embodiments, the operation of determining qualitative data relating to the one or more landmarks using one or more queries at block 410 may be performed by one or more control units 1310. For example, the operation of determining qualitative data relating to the one or more landmarks using one or more queries at block 410 may be performed by a device configured for association with machinery having one or more control units 1310. Alternatively, the operation of determining qualitative data relating to the one or more landmarks using one or more queries at block 410 may be performed by a robot having one or more control units 1310. In some embodiments, determining qualitative data relating to the one or more landmarks using one or more queries at block 410 may include determining qualitative data relating to the one or more landmarks using one or more queries of a data source. For example, robot 1402 may determine qualitative data relating to landmarks L1-L14 using a query of a data source of robot 1404. Alternatively, robot 1402 may determine qualitative data relating to landmarks L1-L14 using a query of a centralized data source configured to store qualitative data relating to one or more environments (e.g. a building layout data file, images, previously determined qualitative data). In some embodiments, determining qualitative data relating to the one or more landmarks using one or more queries at block 410 may include determining qualitative data relating to the one or more landmarks using one or more local and/or remote queries performed via electronic and/or wireless communication. For example, robot 1402 may determine qualitative data relating to landmarks L1-L14 by querying robot 1404 wirelessly, such as to receive qualitative data previously determined by robot 1404. Alternatively, for example, robot 1402 may determine qualitative data relating to landmarks L1-L14 by downloading qualitative data from a mobile device. In some embodiments, determining qualitative data relating to the one or more landmarks using one or more queries at block 410 may include determining qualitative data relating to the one or more landmarks using one or more queries to verify any determined qualitative data. For example, robot 1402 may determine qualitative data for landmarks L1-L14 and then query a user for verification of determined qualitative data (e.g. identified landmarks, types of qualitative data, or values of qualitative data). For example, in one particular embodiment, a robot may determine qualitative data relating to landmarks in an environment using one or more queries of an image or plan, construction or architectural diagram, and/or data source having qualitative data stored or derivable therein.

In some embodiments, the operation of determining qualitative data relating to the one or more landmarks using data input at block 412 may be performed by one or more control units 1310 using one or more device interfaces 1308. For example, the operation of determining qualitative data relating to the one or more landmarks using data input at block 412 may be performed by a device configured for association with machinery having one or more control units 1310 using one or more device interfaces 1308. Alternatively, the operation of determining qualitative data relating to the one or more landmarks using data input at block 412 may be performed by a robot having one or more control units 1310 using one or more device interfaces 1308. In some embodiments, determining qualitative data relating to the one or more landmarks using data input at block 412 may include determining qualitative data relating to the one or more landmarks by downloading previously determined qualitative data. In some embodiments, determining qualitative data relating to the one or more landmarks using data input at block 412 may include determining qualitative data relating to the one or more landmarks using data input received locally and/or remotely via electronic and/or wireless communication. For example, robot 1402 may determine qualitative data relating to landmarks L1-L14 using data input such from downloaded image files, visual representations, spatial representations, audio files, smell data, motion intensity data, light intensity data or some other qualitative data via a device interfacing with the robot 1402 or via wireless communication. In some embodiments, determining qualitative data relating to the one or more landmarks using data input at block 412 may include determining qualitative data relating to the one or more landmarks by receiving data input from another device and/or robot assisting with and/or dedicated to determining qualitative data. For example, robot 1402 may determine qualitative data relating to landmarks L1-L14 by receiving qualitative data from robot 1404, which robot may be dedicated to determining qualitative data. Accordingly, robot 1402 may determine qualitative data more efficiently by enlisting the aid of one or more other robots. In some embodiments, determining qualitative data relating to the one or more landmarks using data input at block 412 may include determining qualitative data relating to the one or more landmarks by receiving satellite image information. For example, robot 1402 may determine qualitative data for landmarks outside and surrounding the office environment at least partially using satellite image information, such as to identify landmarks, assist in determining coordinates for landmarks, suggest likely sounds (e.g. traffic sounds) or light intensities (e.g. shade or full sun areas) relative to landmarks, to assist in preparing spatial representations, or to provide color information related to landmarks. For example, in one particular embodiment, a robot may determine qualitative data relating to landmarks in an environment using data input from a collection of associate robots assisting with collection of qualitative data. Alternatively, in a further particular embodiment, a robot may determine qualitative data relating to landmarks in an environment using a series of images received from one or more strategically mounted and/or movable sensors.

In some embodiments, the operation of determining qualitative data relating to the one or more landmarks using one or more images at block 414 may be performed by one or more control units 1310. For example, the operation of determining qualitative data relating to the one or more landmarks using one or more images at block 414 may be performed by a device configured for association with machinery having one or more control units 1310. Alternatively, the operation of determining qualitative data relating to the one or more landmarks using one or more images at block 414 may be performed by a robot having one or more control units 1310. In some embodiments, determining qualitative data relating to the one or more landmarks using one or more images at block 414 may include determining qualitative data relating to the one or more landmarks using a series of images and/or a video image. For example, robot 1402 may determine qualitative data relating to landmarks L1-L14 using images received via an onboard image sensor or an off-board image sensor, such as a handheld image sensor, an environmentally mounted image sensor, or a sensor on-board another robot. In some embodiments, determining qualitative data relating to the one or more landmarks using one or more images at block 414 may include determining qualitative data relating to the one or more landmarks using a visible image and/or invisible radiation patterns. For example, robot 1402 may determine qualitative data relating to landmarks L1-L14 including colors, shapes, relative orientations with other landmarks, or surface patterns obtained from visible images. In some embodiments, determining qualitative data relating to the one or more landmarks using one or more images at block 414 may include determining qualitative data relating to the one or more landmarks using a filtered and/or unfiltered image. In some embodiments, determining qualitative data relating to the one or more landmarks using one or more images at block 414 may include determining qualitative data relating to the one or more landmarks using one or more images captured on-board or off-board locally and/or remotely. In some embodiments, determining qualitative data relating to the one or more landmarks using one or more images at block 414 may include determining qualitative data relating to the one or more landmarks using one or more images obtained in substantially real-time and/or accessed from a data source. For example, robot 1402 may determine qualitative data relating to landmarks L1-L14 using images obtained while the robot 1402 is moving through the environment. Alternatively, for example, robot 1402 may determine qualitative data relating to landmarks L1-L14 using images previously obtained, such as by another robot, while the robot 1402 is moving through the environment (e.g. robot 1402 may identify landmark L1 and then obtain images related to landmark L1 from a centralized data source of images or from another robot having previously obtained the images). For example, in one particular embodiment, a robot may determine qualitative data relating to landmarks in an environment using images captured using a camera associated with the robot.

In some embodiments, the operation of determining qualitative data relating to one or more corners, curved surfaces, and/or other irregularities at block 416 may be performed by one or more control units 1310. For example, the operation of determining qualitative data relating to one or more corners, curved surfaces, and/or other irregularities at block 416 may be performed by a device configured for association with machinery having one or more control units 1310. Alternatively, the operation of determining qualitative data relating to one or more corners, curved surfaces, and/or other irregularities at block 416 may be performed by a robot having one or more control units 1310. In some embodiments, determining qualitative data relating to one or more corners, curved surfaces, and/or other irregularities at block 416 may include determining qualitative data relating to one or more corners associated with a wall, door, ceiling, stair, floor, curb, post, fence, and/or other indoor or outdoor artificial and/or natural corner. For example, robot 1402 may determine qualitative data relating to corner landmarks L1, L10, L9, L5, L8, L7, and L6. In some embodiments, determining qualitative data relating to one or more corners, curved surfaces, and/or other irregularities at block 416 may 855 include determining qualitative data relating to one or more indoor and/or outdoor artificial and/or natural curved surfaces. For example, robot 1402 may determine qualitative data relating to curved surface landmarks L11 and L16. In some embodiments, determining qualitative data relating to one or more corners, curved surfaces, and/or other irregularities at block 416 may include determining qualitative data relating to one or more irregularities associated with a window, an outlet, a fixture, a picture/painting/print frame, furniture, a shelf, a crate, a floor panel, a drain, a plant, an architectural monument, a bench, a tree, a lamp post, a road, a sign, a bush, a pond, a structure, and/or other indoor or outdoor artificial and/or natural irregularity. For example, robot 1402 may determine qualitative data relating to irregular landmarks L15 and L17. For example, in one particular embodiment, a robot may determine qualitative data relating to substantially all room corners, doors, immovable objects, and/or windows of a commercial and/or residential building. Alternatively, a robot may determine qualitative data relating to substantially all trees, fences, bushes, stumps, structures, and/or obstructions of a lawn. In some embodiments, a robot may determine qualitative data relating to a movable landmark, such as a periodically and regularly movable landmark (e.g. a door opening/closing or manual clock hand movement).

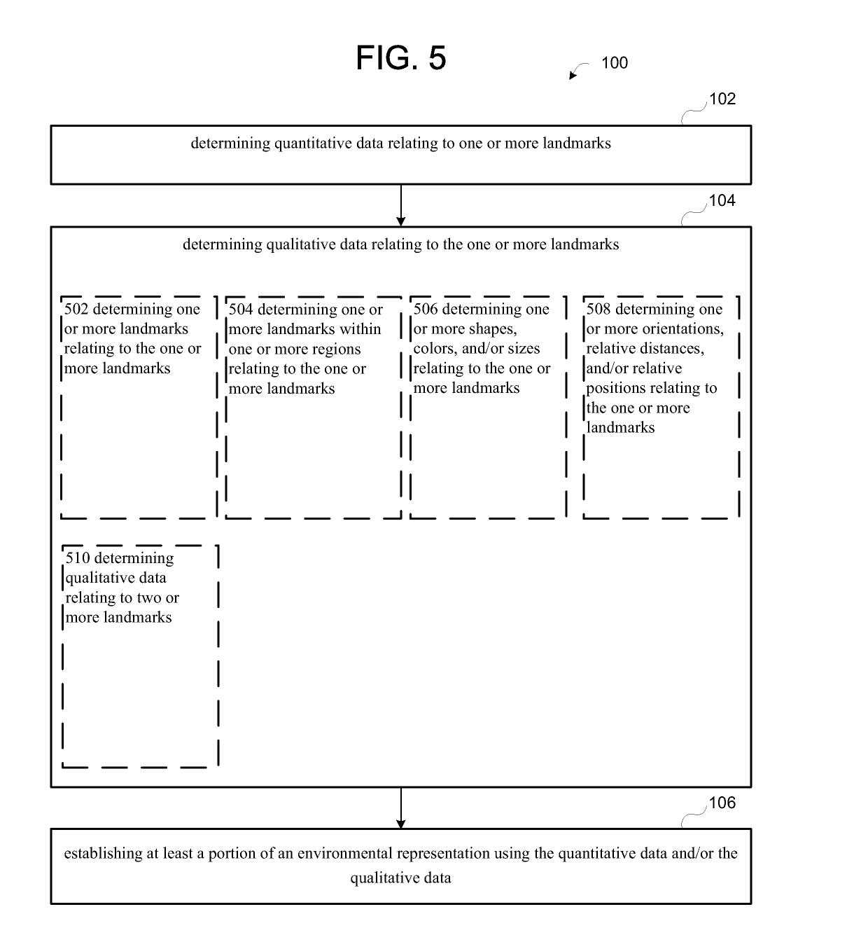

FIG. 5 is a block diagram of various embodiments of a method for establishing an environmental representation, in accordance with various embodiments of the invention. In some embodiments, method 100 may include one or more alternative operations of determining one or more landmarks relating to the one or more landmarks at block 502; determining one or more landmarks within one or more regions relating to the one or more landmarks at block 504; determining one or more shapes, colors, and/or sizes relating to the one or more landmarks at block 506; determining one or more orientations, relative distances, and/or relative positions relating to the one or more landmarks at block 508; and/or determining qualitative data relating to two or more landmarks at block 510.

In some embodiments, the operation of determining one or more landmarks relating to the one or more landmarks at block 502 may be performed by one or more control units 1310. For example, the operation of determining one or more landmarks relating to the one or more landmarks at block 502 may be performed by a device configured for association with machinery having one or more control units 1310. Alternatively, the operation of determining one or more landmarks relating to the one or more landmarks at block 502 may be performed by a robot having one or more control units 1310. In some embodiments, determining one or more landmarks relating to the one or more landmarks at block 502 may include determining an existence of one or more landmarks relative to the one or more landmarks. For example, robot 1402 may determine an existence of landmarks within a spatial field arrangement relative to two other landmarks (FIG. 15), such as robot 1402 may determine landmark L2 to be “lm” or left middle relative to L1 and L12. Additionally, robot 1402 may determine an existence of landmarks within a concentric spatial field arrangement relative to a landmark, such as robot 1402 may determine landmarks L12 and L6 to be within a first concentric zone around landmark L1 and landmarks L4, L2, and L7 to be within a second concentric zone around landmark L1. In some embodiments, determining one or more landmarks relating to the one or more landmarks at block 502 may include determining a visual representation of one or more landmarks relative to the one or more landmarks. For example, robot 1402 may determine a visual representation of landmark L6 from a perspective of landmark L1, a visual representation of landmarks L1 and L6 from a perspective of landmark L2, or a visual representation of landmarks L1, L6, L7, L11, and L2 from landmark L12. The visual representation may be an image, color pattern, shape patter, light intensity pattern, or some other similar visual representation. In some embodiments, determining one or more landmarks relating to the one or more landmarks at block 502 may include determining a spatial representation of one or more landmarks relative to the one or more landmarks. For example, robot 1402 may determine a spatial representation of landmarks L2, L7, and L6 within a field arrangement defined by L8 and L11 (FIG. 15). For example, in one particular embodiment, a robot may determine a visual representation of a landmark viewed from another landmark and/or other perspective. Alternatively, on another particular embodiment, a robot may determine an identity of landmarks within view of another landmark and/or other perspective. In some embodiments, determining one or more landmarks relating to the one or more landmarks at block 502 may include determining a three-dimensional visual representation (e.g. from a top corner above L6 from L12), a three-dimensional spatial representation (e.g. a three-dimensional field arrangement of the type illustrated in FIG. 15), or a three dimensional existence of landmarks (e.g. three-dimensional concentric fields).

In some embodiments, the operation of determining one or more landmarks within one or more regions relating to the one or more landmarks at block 504 may be performed by one or more control units 1310. For example, the operation of determining one or more landmarks within one or more regions relating to the one or more landmarks at block 504 may be performed by a device configured for association with machinery having one or more control units 1310. Alternatively, the operation of determining one or more landmarks within one or more regions relating to the one or more landmarks at block 504 may be performed by a robot having one or more control units 1310. In some embodiments, determining one or more landmarks within one or more regions relating to the one or more landmarks at block 504 may include determining one or more landmarks within one or more regions concentrically defined relative to the one or more landmarks. For example, robot 1402 may determine landmarks L1 and L2 with a first concentric region relative to landmark L12 and may determine landmarks L7, L5, and L4 within a second concentric region relative to landmark L12. In some embodiments, determining one or more landmarks within one or more regions relating to the one or more landmarks at block 504 may include determining one or more landmarks within one or more regions concentrically defined relative to the one or more landmarks, wherein the one or more regions concentrically defined may be shiftable to different planes. For example, robot 1402 may determine landmarks L1 and L2 with a first concentric region relative to landmark L12 on a floor plane and may determine other landmarks within a first concentric region relative to landmark L12 on a plane above the floor plane (e.g. at one, two, three, four feet or another distance off the floor). In some embodiments, determining one or more landmarks within one or more regions relating to the one or more landmarks at block 504 may include determining one or more landmarks within one or more regions concentrically defined in three dimensions relative to the one or more landmarks. In some embodiments, determining one or more landmarks within one or more regions relating to the one or more landmarks at block 504 may include determining one or more landmarks within one or more regions linearly defined relative to the one or more landmarks. For example, using a field arrangement as illustrated in FIG. 15, robot 1402 may determine landmark L2 to be within field “rf” or right front relative to landmarks L13 and L4. In some embodiments, determining one or more landmarks within one or more regions relating to the one or more landmarks at block 504 may include determining one or more landmarks within one or more regions defined with reference to orientation with one or more other landmarks. For example, robot 1402 may determine landmarks L12 and L2 as being in a foreground region relative to landmark L4 as viewed from landmark L6. For example, in one particular embodiment, a robot may determine a spatial representation of landmarks within regions surrounding a landmark and/or within regions surrounding a line connecting two landmarks.

In some embodiments, the operation of determining one or more shapes, colors, and/or sizes relating to the one or more landmarks at block 506 may be performed by one or more control units 1310. For example, the operation of determining one or more shapes, colors, and/or sizes relating to the one or more landmarks at block 506 may be performed by a device configured for association with machinery having one or more control units 1310. Alternatively, the operation of determining one or more shapes, colors, and/or sizes relating to the one or more landmarks at block 506 may be performed by a robot having one or more control units 1310. In some embodiments, determining one or more shapes, colors, and/or sizes relating to the one or more landmarks at block 506 may include determining an outline shape, a detailed shape, a two-dimensional shape, a three-dimensional shape, and/or other shape relating to the one or more landmarks. For example, robot 1402 may determine a shape consisting of a large object supported on a base via a column for landmark L11. Alternatively, robot 1402 may determine a shape consisting of a detailed three-dimensional rendition of landmark L11. Additionally, robot 1402 may determine a two dimensional outline of landmark L11 as viewed from landmark L1. In some embodiments, determining one or more shapes, colors, and/or sizes relating to the one or more landmarks at block 506 may include determining a single color, a multitude of colors, grayscale, and/or other color with course, medium, and/or fine resolution relating to the one or more landmarks. For example, robot 1402 may determine a course resolution color pattern of landmarks L6, L7, L11, or L8. In some embodiments, determining one or more shapes, colors, and/or sizes relating to the one or more landmarks at block 506 may include determining a general, specific, relative, and/or other size relating to the one or more landmarks. For example, robot 1402 may determine a height of landmark L2 being floor to ceiling and a height of landmark L7 as being ⅖ floor to ceiling (e.g. a desktop height). Other embodiments may also include determining one or more textures, hardness, sounds, tastes, smells, and/or other characteristic relating to the one or more landmarks. For example, robot 1402 may determine a soft compressible texture of landmark L11. Alternatively, robot 1402 may determine a high hardness of landmark L8. Additionally, robot 1402 may determine door closing sounds proximate to landmark L6. For example, in one specific embodiment, a robot may determine an outline shape, color pattern, height, and width of a landmark as well as sound patterns of the landmark.

In some embodiments, the operation of determining one or more orientations, relative distances, and/or relative positions relating to the one or more landmarks at block 508 may be performed by one or more control units 1310. For example, the operation of determining one or more orientations, relative distances, and/or relative positions relating to the one or more landmarks at block 508 may be performed by a device configured for association with machinery having one or more control units 1310. Alternatively, the operation of determining one or more orientations, relative distances, and/or relative positions relating to the one or more landmarks at block 508 may be performed by a robot having one or more control units 1310. In some embodiments, determining one or more orientations, relative distances, and/or relative positions relating to the one or more landmarks at block 508 may include determining one or more orientations of the one or more landmarks relative to one or more other landmarks. For example, robot 1402 may determine that landmark L6 is parallel with landmark L1 (e.g. both landmarks L6 and L1 have a corner edge extending perpendicularly from a floor). Additionally, robot 1402 may determine that landmark L15 is perpendicular with landmark L1 (e.g. landmark L15 is a table surface parallel with a floor and landmark L1 is a corner edge extending perpendicularly from a floor). In some embodiments, determining one or more orientations, relative distances, and/or relative positions relating to the one or more landmarks at block 508 may include determining one or more distances between the one or more landmarks relative to one or more other landmarks. For example, robot 1402 may determine a distance from landmark L8 to landmark L7. Alternatively, robot 1402 may determine a perceived distance from landmark L8 to landmark L7 from a perspective of landmark L1. Additionally, robot 1402 may determine a distance between landmark L15 and landmark L1 (e.g. distances between landmarks in three dimensions). In some embodiments, determining one or more orientations, relative distances, and/or relative positions relating to the one or more landmarks at block 508 may include determining one or more positions, such as above, below, inside, outside, around, through, touching, and/or separated, of the one or more landmarks relative to one or more other landmarks. For example, robot 1402 may determine landmark L11 to be in front of landmark L8 from a perspective of landmark L7. Additionally, robot 1402 may determine landmark L11 to be below landmark L7 (e.g. a chair below a surface of a desk). For example, in one particular embodiment, a robot may determine a shelf to be vertically aligned with, adjacent to, and touching a wall and/or any other topological relationship.

In some embodiments, the operation of determining qualitative data relating to two or more landmarks at block 510 may be performed by one or more control units 1310. For example, the operation of determining qualitative data relating to two or more landmarks at block 510 may be performed by a device configured for association with machinery having one or more control units 1310. Alternatively, the operation of determining qualitative data relating to two or more landmarks at block 510 may be performed by a robot having one or more control units 1310. In some embodiments, determining qualitative data relating to two or more landmarks at block 510 may include determining one or more landmarks relating to the two or more landmarks. For example, robot 1402 may determine landmark L6 to be certain distances and angles from L1 and L7. In some embodiments, determining qualitative data relating to two or more landmarks at block 510 may include determining one or more landmarks within one or more regions relating to the two or more landmarks. For example, robot 1402 may determine landmark L6 to be “1” or left within a field arraignment, such as that illustrated in FIG. 15. Alternatively robot 1402 may determine landmarks L6, L7, L11, and L8 to be in a first concentric region relative to L2 and L12. In some embodiments, the one or more regions relating to the two or more landmarks are two or three-dimensionally defined relative to the two or more landmarks. In some embodiments, determining qualitative data relating to two or more landmarks at block 510 may include determining one or more shapes, colors, and/or sizes relating to two or more landmarks. For example, robot 1402 may determine a shape, color, and size of landmarks L7, L11, and L8 from any perspective on or between landmarks L1 and L6. In some embodiments, determining qualitative data relating to two or more landmarks at block 510 may include determining one or more orientations, relative distances, and/or relative positions relating to two or more landmarks. For example, robot 1402 may determine an orientation of L7 with respect to L1 and L6 (e.g. parallel, perpendicular, angularly, or another orientation). Alternatively, robot 1402 may determine and orientation of L7 and L8 with respect to L1 (e.g. an orientation of two or more landmarks with respect to one or more landmarks or an orientation of one or more landmarks with respect to two or more landmarks). In some embodiments, determining qualitative data relating to two or more landmarks at block 510 may include determining one or more textures, hardness, sounds, tastes, smells, and/or other characteristic relating to two or more landmarks. For example, robot 1402 may determine sounds at or between landmarks L2 and L6 (e.g. door opening and closing sound becoming more intense upon approach from L2 to L6). Alternatively, robot 1402 may determine textures of L12 and L11 (e.g. wood door frame versus cloth chair). Additionally, robot 1402 may determine textures along a path between L12 and L11 (e.g. carpet or flooring).

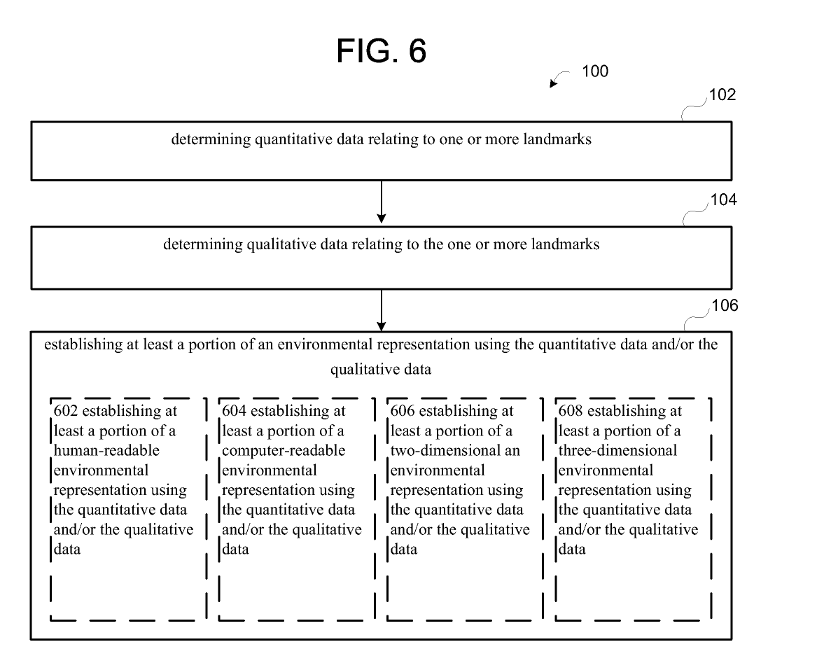

FIG. 6 is a block diagram of various embodiments of a method for establishing an environmental representation, in accordance with various embodiments of the invention. In some embodiments, method 100 may include one or more alternative operations of establishing at least a portion of a human-readable environmental representation using the quantitative data and/or the qualitative data at block 602; establishing at least a portion of a computer-readable environmental representation using the quantitative data and/or the qualitative data at block 604; establishing at least a portion of a two-dimensional environmental representation using the quantitative data and/or the qualitative data at block 606; and establishing at least a portion of a three-dimensional environmental representation using the quantitative data and/or the qualitative data at block 608.

In some embodiments, the operation of establishing at least a portion of a human-readable environmental representation using the quantitative data and/or the qualitative data at block 602 may be performed by one or more control units 1310. For example, the operation of establishing at least a portion of a human-readable environmental representation using the quantitative data and/or the qualitative data at block 602 may be performed by a device configured for association with machinery having one or more control units 1310. Alternatively, the operation of establishing at least a portion of a human-readable environmental representation using the quantitative data and/or the qualitative data at block 602 may be performed by a robot having one or more control units 1310. In some embodiments, establishing at least a portion of a human-readable environmental representation using the quantitative data and/or the qualitative data at block 602 may include establishing at least a portion of a human-readable environmental representation, such as having plan, perspective, exploded, and/or navigatable views, having landmarks and any related quantitative data and/or qualitative data displayed and/or or accessible therein. For example, robot 1402 may establish an environmental representation substantially similar to that illustrated in FIG. 14 with landmarks designated and quantitative and/or qualitative data accessible from the same. In some embodiments, robot 1402 may establish an environmental representation from scratch or using a template, such as an architectural floor plan. In some embodiments, establishing at least a portion of a human-readable environmental representation using the quantitative data and/or the qualitative data at block 602 may include establishing a computer model environmental representation using the quantitative data and/or the qualitative data. In some embodiments, establishing at least a portion of a human-readable environmental representation using the quantitative data and/or the qualitative data at block 602 may include establishing a printed environmental representation using the quantitative data and/or the qualitative data. For example, in one particular embodiment, a robot may establish a computer model environmental representation containing substantially all landmarks, with substantially all determined quantitative data and/or qualitative data for each of the landmarks displayed or accessible therein.

In some embodiments, the operation of establishing at least a portion of a computer-readable environmental representation using the quantitative data and/or the qualitative data at block 604 may be performed by one or more control units 1310. For example, the operation of establishing at least a portion of a computer-readable environmental representation using the quantitative data and/or the qualitative data at block 604 may be performed by a device configured for association with machinery having one or more control units 1310. Alternatively, the operation of establishing at least a portion of a computer-readable environmental representation using the quantitative data and/or the qualitative data at block 604 may be performed by a robot having one or more control units 1310. In some embodiments, establishing at least a portion of a computer-readable environmental representation using the quantitative data and/or the qualitative data at block 604 may include establishing at least a portion of a computer-readable environmental representation, such as having plan, perspective, exploded, and/or navigatable views, having landmarks and any related quantitative data and/or qualitative data accessible therein. In some embodiments, establishing at least a portion of a computer-readable environmental representation using the quantitative data and/or the qualitative data at block 604 may include establishing at least a portion of a computer-readable environmental representation, such as within a database and/or files, having landmarks and any related quantitative data and/or qualitative data accessible therein. For example, robot 1402 may establish an environmental representation including a database containing landmarks and any quantitative and/or qualitative data associated therewith, which database contents may not necessarily be translated into a visual representation. In some embodiments, establishing at least a portion of a computer-readable environmental representation using the quantitative data and/or the qualitative data at block 604 may include establishing at least a portion of a computer-readable environmental representation locally and/or remotely using the quantitative data and/or the qualitative data. For example, robot 1402 may establish an environmental representation on-board, may assist another robot in establishing an environmental representation, or may establish an environmental representation off-board, such as at a control station or centralized repository. In some embodiments, establishing at least a portion of a computer-readable environmental representation using the quantitative data and/or the qualitative data at block 604 may include establishing at least a portion of a computer-readable environmental representation in association with one or more portions of the environmental representation contributed from one or more other sources. For example, robot 1402 may establish an environmental representation using quantitative or qualitative data contributed from another robot, using previously determined environmental representations, or using visual illustrations, such as architectural floor plans, pictures, videos, schematics, CAD drawings, or other similar illustration. For example, in one particular embodiment, a robot may establish a set of database field and value entries, or any other ontology, referencing substantially all landmarks, with substantially all determined quantitative and/or qualitative data for each of the landmarks associated with or accessible therefrom.

In some embodiments, the operation of establishing at least a portion of a two-dimensional environmental representation using the quantitative data and/or the qualitative data at block 606 may be performed by one or more control units 1310. For example, the operation of establishing at least a portion of a two-dimensional environmental representation using the quantitative data and/or the qualitative data at block 606 may be performed by a device configured for association with machinery having one or more control units 1310. Alternatively, the operation of establishing at least a portion of a two-dimensional environmental representation using the quantitative data and/or the qualitative data at block 606 may be performed by a robot having one or more control units 1310. In some embodiments, establishing at least a portion of a two-dimensional environmental representation using the quantitative data and/or the qualitative data at block 606 may include establishing at least a portion of floor environmental representation of a commercial space, industrial space, residential space, commercial outdoor property, industrial outdoor property, residential outdoor property, and/or other space or property, using the quantitative data and/or the qualitative data. In some embodiments, establishing at least a portion of a two-dimensional environmental representation using the quantitative data and/or the qualitative data at block 606 may include establishing at least a portion of a two-dimensional environmental representation having at least some three-dimensional quantitative and/or qualitative data using the quantitative data and/or the qualitative data. In some embodiments, establishing at least a portion of a two-dimensional environmental representation using the quantitative data and/or the qualitative data at block 606 may include establishing a plurality of two dimensional environmental representations linked via common landmarks (e.g. different floors of a building or an indoor and outdoor space). For example, in one particular embodiment, a robot may establish an environmental representation of a floor of a warehouse having substantially all landmarks, with substantially all determined quantitative and/or qualitative data for each of the landmarks displayed or accessible therein, wherein the robot may use the environmental representation to identify its position and/or navigate in two-dimensions and/or two and one-half dimensions. This embodiment may be useful in robotic cleaning, transport, movement, mowing, security, guarding, service, interaction and/or other autonomous and intelligent robotic functions.

In some embodiments, the operation of establishing at least a portion of a three-dimensional environmental representation using the quantitative data and/or the qualitative data at block 608 may be performed by one or more control units 1310. For example, the operation of establishing at least a portion of a three-dimensional environmental representation using the quantitative data and/or the qualitative data at block 608 may be performed by a device configured for association with machinery having one or more control units 1310. Alternatively, the operation of establishing at least a portion of a three-dimensional environmental representation using the quantitative data and/or the qualitative data at block 608 may be performed by a robot having one or more control units 1310. In some embodiments, establishing at least a portion of a three-dimensional environmental representation using the quantitative data and/or the qualitative data at block 608 may include establishing at least a portion of a three-dimensional environmental representation of a commercial space, industrial space, residential space, commercial outdoor property, industrial outdoor property, residential outdoor property, and/or other space or property, using the quantitative data and/or the qualitative data. In some embodiments, establishing at least a portion of a three-dimensional environmental representation using the quantitative data and/or the qualitative data at block 608 may include establishing at least a portion of a three-dimensional environmental representation having at least some two-dimensional quantitative and/or qualitative data using the quantitative data and/or the qualitative data. For example, in one particular embodiment, a robot may establish an environmental representation of an entire warehouse having substantially all landmarks, with substantially all determined quantitative and/or qualitative data for each of the landmarks displayed or accessible therein, wherein the robot may use the environmental representation to identify its position and/or navigate in three-dimensions. This embodiment may be useful in robotic flying, palette/rack storage and retrieval, movement between floors of a building, above surface cleaning, transport, movement, and/or other functions, such as those discussed above.

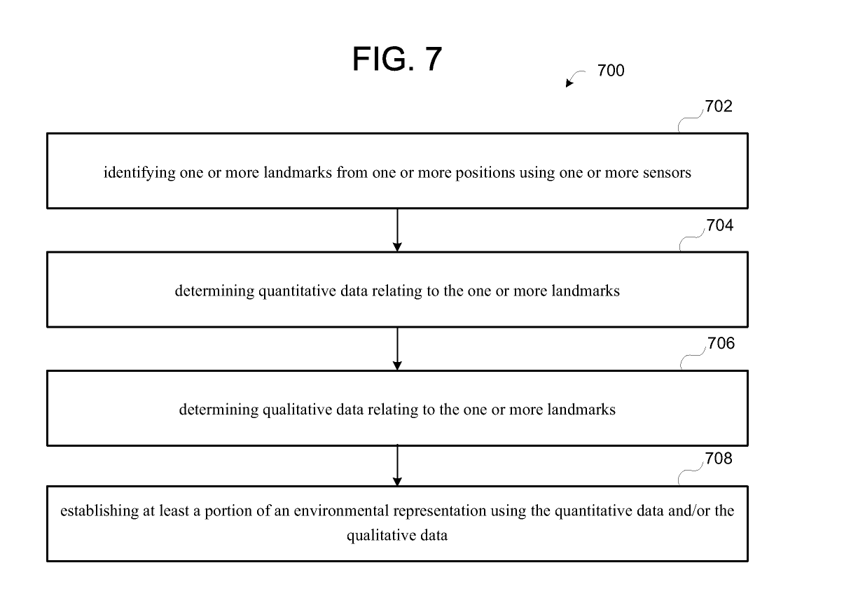

FIG. 7 is a block diagram of a method for establishing an environmental representation, in accordance with an embodiment of the invention. In some embodiments, method 700 may include operations of identifying one or more landmarks from one or more positions using one or more sensors at block 702; determining quantitative data relating to one or more landmarks at block 704; determining qualitative data relating to the one or more landmarks at block 706; and establishing at least a portion of an environmental representation using the quantitative data and/or the qualitative data at block 708. In some embodiments, method 700 may include one or more alternative embodiments discussed with reference to method 100.

In some embodiments, the operation of identifying one or more landmarks from one or more positions using one or more sensors at block 702 may be performed by one or more control units 1310 using one or more sensors 1302. For example, the operation of identifying one or more landmarks from one or more positions using one or more sensors at block 702 may be performed by a device configured for association with machinery having one or more control units 1310 using one or more sensors 1302. Alternatively, the operation of identifying one or more landmarks from one or more positions using one or more sensors at block 702 may be performed by a robot having one or more control units 1310 using one or more sensors 1302. In some embodiments, identifying one or more landmarks from one or more positions using one or more sensors at block 702 may include discovering a landmark, determining a position of a landmark, determining a relationship of a landmark, characterizing a landmark, and/or otherwise identifying a landmark. For example, robot 1402 may identify landmarks L2, L5, and L12 from position 1 and/or position 2 using one or more on-board sensors. Alternatively, robot 1402 may identifying landmarks L2, L5, and L12 using one or more off-board sensors, such as an environmentally mounted sensor or a mobile sensor. In some embodiments, identifying one or more landmarks from one or more positions using one or more sensors at block 702 may include identifying an internal, external, artificial, and/or natural landmark.

In some embodiments, the operation of determining quantitative data relating to the one or more landmarks at block 704 may be performed by one or more control units 1310. For example, the operation of determining quantitative data relating to the one or more landmarks at block 704 may be performed by a device configured for association with machinery having one or more control units 1310. Alternatively, the operation of determining quantitative data relating to the one or more landmarks at block 704 may be performed by a robot having one or more control units 1310. In some embodiments, determining quantitative data relating to the one or more landmarks at block 704 may include determining a distance, angle, an existence of an opening, a height, a width, a length, a coordinate, and/or any other quantitative data relating to one or more landmarks. For example, robot 1402 may determine quantitative data relating to landmarks L1-L14. In some embodiments, determining quantitative data relating to the one or more landmarks at block 704 may include determining quantitative data relating to a landmark being interior, exterior, artificial, natural, and/or of any other property.

In some embodiments, the operation of determining qualitative data relating to the one or more landmarks at block 706 may be performed by one or more control units 1310. For example, the operation of determining qualitative data relating to the one or more landmarks at block 706 may be performed by a device configured for association with machinery having one or more control units 1310. Alternatively, the operation of determining qualitative data relating to the one or more landmarks at block 706 may be performed by a robot having one or more control units 1310. In some embodiments, determining qualitative data relating to the one or more landmarks at block 706 may include determining a color, a texture, a shape, an odor, a sound, a flavor, a spatial relationship, a relative position relationship, an orientation, and/or any other qualitative data relating to the one or more landmarks. For example, robot 1402 may determine qualitative data relating to landmarks L1-L14. In some embodiments, determining qualitative data relating to the one or more landmarks at block 706 may include determining qualitative data relating to a landmark being interior, exterior, artificial, natural, and/or of any other property.

In some embodiments, the operation of establishing at least a portion of an environmental representation using the quantitative data and/or the qualitative data at block 708 may be performed by one or more control units 1310. For example, the operation of establishing at least a portion of an environmental representation using the quantitative data and/or the qualitative data at block 708 may be performed by a device configured for association with machinery having one or more control units 1310. Alternatively, the operation of establishing at least a portion of an environmental representation using the quantitative data and/or the qualitative data at block 708 may be performed by a robot having one or more control units 1310. In some embodiments, establishing at least a portion of an environmental representation using the quantitative data and/or the qualitative data at block 708 may include establishing at least a portion of an environmental representation including the one or more landmarks associated with the quantitative data and/or the qualitative data determined for the one or more landmarks. For example, robot 1402 may establish an environmental representation including landmarks L1-L14 associated with the quantitative data and the qualitative data determined for the same. In some embodiments, establishing at least a portion of an environmental representation using the quantitative data and/or the qualitative data at block 708 may include establishing an environmental representation of an internal, external, artificial, and/or natural environment using the quantitative data and/or the qualitative data.

Accordingly, in some embodiments, method 700 may be used to establish an environmental representation of a warehouse, an office space, a home, a boat, an airport, a school, a yard, a shopping center, a city, a state, a country, a marina, and/or any other environment including landmarks associated with quantitative and/or qualitative data. In some embodiments, an established environmental representation including landmarks associated with quantitative and/or qualitative data can be used for navigation and/or positional determinations within an environment.

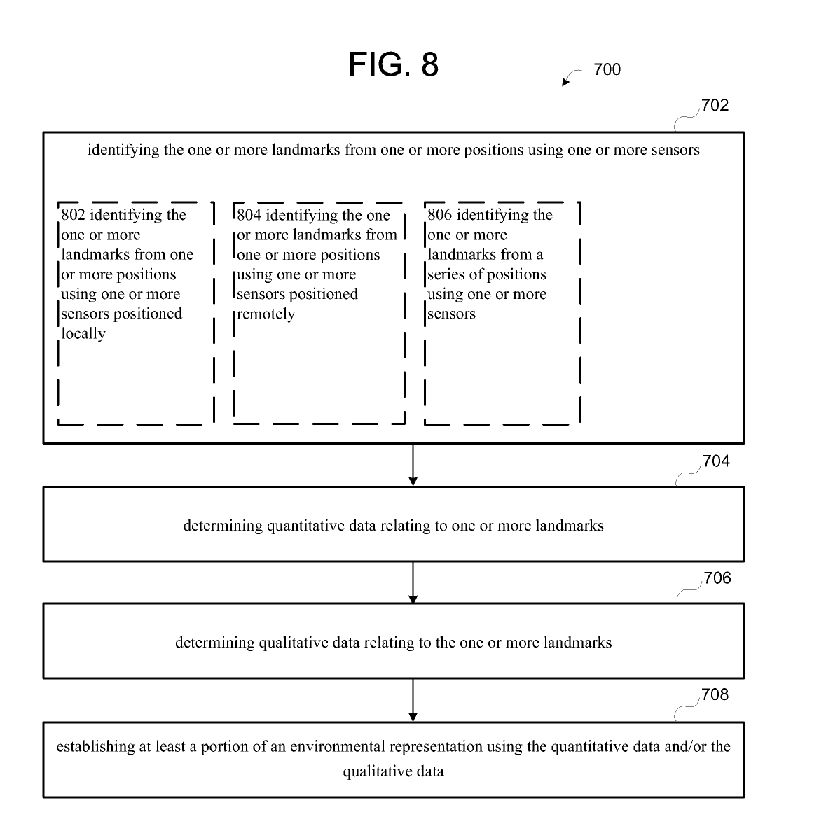

FIG. 8 is a block diagram of various embodiments of a method for establishing an environmental representation, in accordance with various embodiments of the invention. In some embodiments, method 700 may include one or more alternative operations of identifying the one or more landmarks from one or more positions using one or more sensors positioned locally at block 802; identifying the one or more landmarks from one or more positions using one or more sensors positioned remotely at block 804; and identifying the one or more landmarks from a series of positions using one or more sensors at block 806.

In some embodiments, the operation of identifying the one or more landmarks from one or more positions using one or more sensors positioned locally at block 802 may be performed by one or more control units 1310 using one or more sensors 1302. For example, the operation of identifying the one or more landmarks from one or more positions using one or more sensors positioned locally at block 802 may be performed by a device configured for association with machinery having one or more control units 1310 using one or more sensors 1302. Alternatively, the operation of identifying the one or more landmarks from one or more positions using one or more sensors positioned locally at block 802 may be performed by a robot having one or more control units 1310 using one or more sensors 1302. In some embodiments, identifying the one or more landmarks from one or more positions using one or more sensors positioned locally at block 802 may include identifying the one or more landmarks from one or more positions using one or more sensors positioned on a device configured for navigating and/or controlling machinery, such as a machine for cleaning, transporting, moving, lifting, cutting, trimming, serving, assisting, and/or other function, such as those discussed above. In some embodiments, identifying the one or more landmarks from one or more positions using one or more sensors positioned locally at block 802 may include identifying the one or more landmarks from one or more positions using one or more sensors positioned on a robot configured for cleaning, transporting, moving, lifting, cutting, trimming, serving, assisting, and/or other function, such as those discussed above. For example, robot 1402 may identify landmarks L12, L2, and L5 from position 1 and position 2 using one or more sensors positioned on robot 1402. Alternatively, robot 1402 and robot 1404 may identify landmarks L12, L2, and L5 from position 1 and position 2 using one or more sensors positioned on robot 1402 and/or one or more sensors positioned on robot 1404. In some embodiments, identifying the one or more landmarks from one or more positions using one or more sensors positioned locally at block 802 may include identifying the one or more landmarks from one or more positions using one or more sensors positioned on a plurality of devices configured for association with machinery and/or robots. In some embodiments, identifying the one or more landmarks from one or more positions using one or more sensors positioned locally at block 802 may include identifying the one or more landmarks from one or more positions using one or more sensors removably and/or interchangeably positioned locally. For example, in one particular embodiment, a robot with a sensor may identify landmarks as it moves through an environment. Locally as used herein may imply on-board a robot or device or operably coupled with a robot or device.

In some embodiments, the operation of identifying the one or more landmarks from one or more positions using one or more sensors positioned remotely at block 804 may be performed by one or more control units 1310 using one or more sensors 1302. For example, the operation of identifying the one or more landmarks from one or more positions using one or more sensors positioned remotely at block 804 may be performed by a device configured for association with machinery having one or more control units 1310 using one or more sensors 1302. Alternatively, the operation of identifying the one or more landmarks from one or more positions using one or more sensors positioned remotely at block 804 may be performed by a robot having one or more control units 1310 using one or more sensors 1302. In some embodiments, identifying the one or more landmarks from one or more positions using one or more sensors positioned remotely at block 804 may include identifying the one or more landmarks from one or more positions using one or more sensors movably and/or fixably positioned off of a device configured for navigating and/or controlling machinery, such as a machine for cleaning, transporting, moving, lifting, cutting, trimming, serving, assisting, and/or other function, such as those discussed above. In some embodiments, identifying the one or more landmarks from one or more positions using one or more sensors positioned remotely at block 804 may include identifying the one or more landmarks from one or more positions using one or more sensors movably and/or fixably positioned off-board a robot configured for cleaning, transporting, moving, lifting, cutting, trimming, serving, assisting, and/or other function, such as those discussed above. For example, robot 1402 may identify landmarks L1-L14 as it moves through the environment using one or more sensors movably positioned in the environment off-board robot 1402. In some embodiments, identifying the one or more landmarks from one or more positions using one or more sensors positioned remotely at block 804 may include identifying the one or more landmarks from one or more positions using one or more sensors movably and/or fixably positioned off of a plurality of devices configured for association with machinery and/or robots. In some embodiments, identifying the one or more landmarks from one or more positions using one or more sensors positioned remotely at block 804 may include identifying the one or more landmarks from one or more positions using a plurality of sensors movably and/or fixably positioned off-board a device configured for association with a machinery and/or robot. In some embodiments, identifying the one or more landmarks from one or more positions using one or more sensors positioned remotely at block 804 may include identifying the one or more landmarks from one or more positions using one or more sensors removably and/or interchangeably positioned remotely. For example, in one particular embodiment, a robot communicatably linked with an environmentally mounted sensor may identify landmarks as it moves through the environment. Remotely as used herein may imply off-board a robot or device, positioned within an environment, or movable within the environment.

In some embodiments, the operation of identifying the one or more landmarks from a series of positions using one or more sensors at block 806 may be performed by one or more control units 1310 using one or more sensors 1302. For example, the operation of identifying the one or more landmarks from a series of positions using one or more sensors at block 806 may be performed by a device configured for association with machinery having one or more control units 1310 using one or more sensors 1302. Alternatively, the operation of identifying the one or more landmarks from a series of positions using one or more sensors at block 806 may be performed by a robot having one or more control units 1310 using one or more sensors 1302. In some embodiments, identifying the one or more landmarks from a series of positions using one or more sensors at block 806 may include identifying the one or more landmarks from a series of positions corresponding to different zones, regions, and/or areas of an environment using one or more sensors. For example, robot 1402 may identify landmarks within the environment from position 1, position 2, or other positions. Additionally, robot 1402 may identify landmarks within the environment from view 1, view 2, view 3, or other views at position 1. Moreover, positions and views may be two dimensional or three-dimensional. In some embodiments, identifying the one or more landmarks from a series of positions using one or more sensors at block 806 may include identifying the one or more landmarks from a series of views at each of the series of positions using one or more sensors. For example, robot 1402 may identify landmarks a position 1 while rotating through views 1, 2, and 3 before moving to position 2 and other positions and similarly rotating through views. In some embodiments, identifying the one or more landmarks from a series of positions using one or more sensors at block 806 may include identifying the one or more landmarks from a series of positions determined based upon relationships with the one or more landmarks using one or more sensors. For example, robot 1402 may identify landmarks L2 and L5 from position 1 and then determine a subsequent position to be at or between landmarks L2 or L5. For example, in one particular embodiment, a robot may move to a first position and identify all landmarks within a first view, rotate at the first position and identify all landmarks within a second view, and repeat these steps until all landmarks at the first position have been identified. Subsequently, the robot may move to a second position with a known relationship to the first position and/or an identified landmark and identify all landmarks within a first view, rotate at the second position and identify all landmarks within a second view, and repeat these steps until all landmarks at the second position have been identified. The robot may repeat these steps until all landmarks in an environment have been identified.

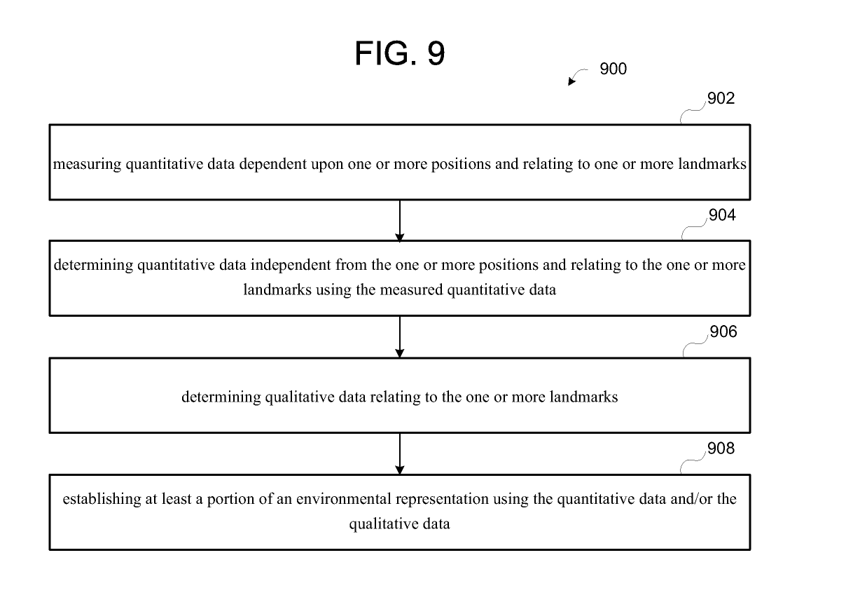

FIG. 9 is a block diagram of a method for establishing an environmental representation, in accordance with an embodiment of the invention. In some embodiments, method 900 may include operations of measuring quantitative data dependent upon one or more positions and relating to one or more landmarks at block 902; determining quantitative data independent from the one or more positions and relating to the one or more landmarks using the measured quantitative data at block 904; determining qualitative data relating to the one or more landmarks at block 906; and establishing at least a portion of an environmental representation using the quantitative data and/or the qualitative data at block 908. In some embodiments, method 900 may include one or more alternative embodiments discussed with reference to methods 100 and/or 700.

In some embodiments, the operation of measuring quantitative data dependent upon one or more positions and relating to one or more landmarks at block 902 may be performed by one or more control units 1310. For example, the operation of measuring quantitative data dependent upon one or more positions and relating to one or more landmarks at block 902 may be performed by a device configured for association with machinery having one or more control units 1310. Alternatively, the operation of measuring quantitative data dependent upon one or more positions and relating to one or more landmarks at block 902 may be performed by a robot having one or more control units 1310. In some embodiments, measuring quantitative data dependent upon one or more positions and relating to one or more landmarks at block 902 may include measuring quantitative data dependent upon one or more positions and relating to one or more landmarks using one or more sensors. For example, robot 1402 may measure quantitative data of landmarks L1-L14 dependent upon position 1 using one or more on-board or off-board sensors. In some embodiments, measuring quantitative data dependent upon one or more positions and relating to one or more landmarks at block 902 may include measuring a distance and/or angle dependent upon one or more positions and relating to one or more landmarks. For example, robot 1402 may measure a distance between position 1 and landmark L1 and between position 1 and landmark L12. Additionally, robot 1402 may measure an angle at position 1 with landmarks L1 and L2. In some embodiments, measuring quantitative data dependent upon one or more positions and relating to one or more landmarks at block 902 may include measuring quantitative data dependent upon one or more positions and relating to a landmark being interior, exterior, artificial, natural, and/or of any other property. For example, in one particular embodiment, a robot may measure distances and angles to a plurality of landmarks from its position.

In some embodiments, the operation of determining quantitative data independent from the one or more positions and relating to the one or more landmarks using the measured quantitative data at block 904 may be performed by one or more control units 1310. For example, the operation of determining quantitative data independent from the one or more positions and relating to the one or more landmarks using the measured quantitative data at block 904 may be performed by a device configured for association with machinery having one or more control units 1310. Alternatively, the operation of determining quantitative data independent from the one or more positions and relating to the one or more landmarks using the measured quantitative data at block 904 may be performed by a robot having one or more control units 1310. In some embodiments, determining quantitative data independent from the one or more positions and relating to the one or more landmarks using the measured quantitative data at block 904 may include determining a distance from the one or more landmarks to another landmark using the measured quantitative data. For example, robot 1402 may determine through geometric calculations a distance between landmark L1 and L12 using measured quantitative data such as the distances between position 1 and landmark L1 and position 1 and landmark L12 and the angle at position 1 with landmarks L1 and L12. In some embodiments, determining quantitative data independent from the one or more positions and relating to the one or more landmarks using the measured quantitative data at block 904 may include determining an angle at the one or more landmarks with another landmark using the measured quantitative data. For example, robot 1402 may determine through geometric calculations an angle at landmark L12 with landmarks L1 and L2. In some embodiments, determining quantitative data independent from the one or more positions and relating to the one or more landmarks using the measured quantitative data at block 904 may include determining a height, width, shape, and/or other feature of the one or more landmarks using the measured quantitative data. In some embodiments, determining quantitative data independent from the one or more positions and relating to the one or more landmarks using the measured quantitative data at block 904 may include determining quantitative data independent from the one or more positions and relating to the one or more landmarks being interior, exterior, artificial, natural, and/or of any other property using the measured quantitative data. For example, in one particular embodiment, a robot may determine distances between substantially all landmarks and/or angles between substantially all landmarks, which are independent of any position of the robot, using quantitative data measured by the robot from one or more positions.

In some embodiments, the operation of determining qualitative data relating to the one or more landmarks at block 906 may be performed by one or more control units 1310. For example, the operation of determining qualitative data relating to the one or more landmarks at block 906 may be performed by a device configured for association with machinery having one or more control units 1310. Alternatively, the operation of determining qualitative data relating to the one or more landmarks at block 906 may be performed by a robot having one or more control units 1310. In some embodiments, determining qualitative data relating to the one or more landmarks at block 906 may include determining a color, a radiation pattern, an image, a texture, a shape, an odor, a sound, a flavor, hardness, periodic movement, random movement, a spatial relationship, a relative position relationship, an orientation, and/or any other qualitative 1485 data relating to the one or more landmarks. For example, robot 1402 may determine a color of landmark L11; a color pattern of landmarks L7, L11, and L8 from a perspective of landmark L1, an image of landmark L17, a texture of a floor between landmarks L12 and L6; a shape of landmark L1; an odor intensity at landmark L5; a sound at landmark L6, a position of landmark L6 within a two or three dimensional field arrangement relative to landmarks L1 and L7; a relative position of landmark L11 relative to landmark L8 from a perspective of landmark L1; a perpendicular orientation of landmark L15 relative to landmark L1; movement relative to landmark L6 (e.g. foot traffic); movement of landmark L11 (e.g. chair swiveling or movement); or some other similar qualitative data. In some embodiments, determining qualitative data relating to the one or more landmarks at block 906 may include determining two or three-dimensional qualitative data. In some embodiments, determining qualitative data relating to the one or more landmarks at block 906 may include determining qualitative data relating to a landmark being interior, exterior, artificial, natural, and/or of any other property.

In some embodiments, the operation of establishing at least a portion of an environmental representation using the quantitative data and/or the qualitative data at block 908 may be performed by one or more control units 1310. For example, the operation of establishing at least a portion of an environmental representation using the quantitative data and/or the qualitative data at block 908 may be performed by a device configured for association with machinery having one or more control units 1310. Alternatively, the operation of establishing at least a portion of an environmental representation using the quantitative data and/or the qualitative data at block 908 may be performed by a robot having one or more control units 1310. In some embodiments, establishing at least a portion of an environmental representation using the quantitative data and/or the qualitative data at block 908 may include establishing at least a portion of an environmental representation including the one or more landmarks associated with the quantitative data and/or the qualitative data determined for the one or more landmarks. In some embodiments, establishing at least a portion of an environmental representation using the quantitative data and/or the qualitative data at block 908 may include establishing an environmental representation of an internal, external, artificial, and/or natural environment using the quantitative data and/or the qualitative data. For example, robot 1402 may establish an environmental representation on-board or off-board as it moves through its environment in real-time or via batch processing.

Accordingly, in some embodiments, method 900 may be used to establish an environmental representation of a warehouse, an office space, a home, a boat, an airport, a school, a yard, a shopping center, a city, a state, a country, a marina, and/or any other environment including landmarks associated with quantitative and/or qualitative data. In some embodiments, an established environmental representation including landmarks associated with quantitative and/or qualitative data can be used for navigation, localization, and/or positional determinations within an environment.

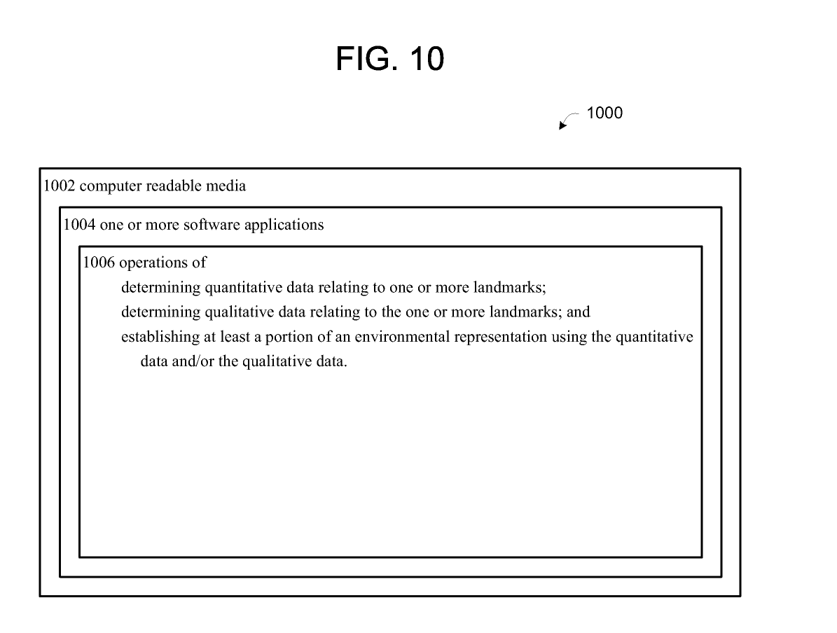

FIG. 10 is a system diagram of one or more software applications embodied in computer readable media for establishing an environmental representation, in accordance with an embodiment of the invention. In some embodiments, system 1000 may include one or more software applications 1004 embodied in computer readable media 1002 for performing operations 1006 of determining quantitative data relating to one or more landmarks; determining qualitative data relating to the one or more landmarks; and establishing at least a portion of an environmental representation using the quantitative data and/or the qualitative data. In some embodiments, system 1000 may include one or more software applications 1004 embodied in computer readable media 1002 for performing operations 1006 of any embodiment disclosed herein. In some embodiments, computer readable media 1002 may include volatile memory, non-volatile memory, an electronic signal, a wireless signal, an optical signal, and/or other media.

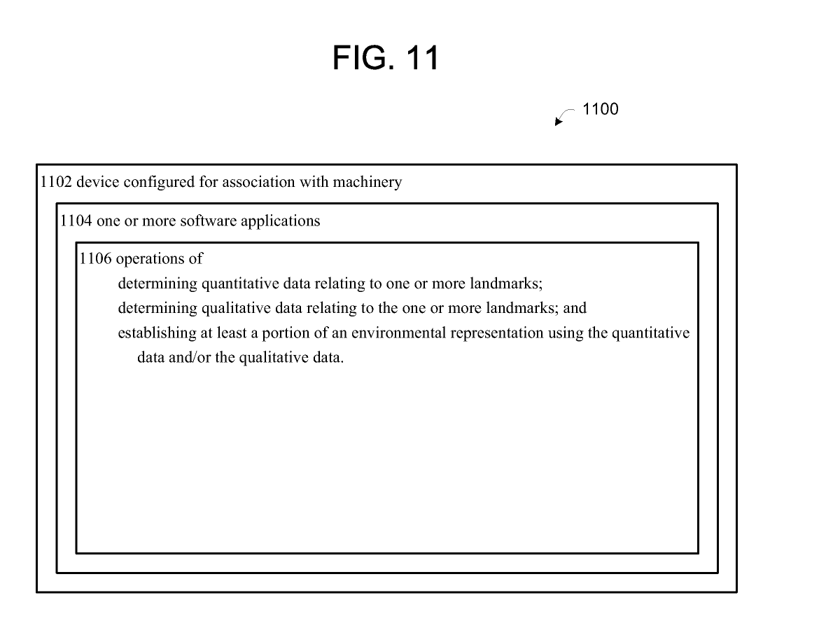

FIG. 11 is a system diagram of one or more software applications embodied in a device configured for association with machinery for establishing an environmental representation, in accordance with an embodiment of the invention. In some embodiments, system 1100 may include one or more software applications 1104 embodied in a device 1102 configured for association with machinery for performing operations 1106 of determining quantitative data relating to one or more landmarks; determining qualitative data relating to the one or more landmarks; and establishing at least a portion of an environmental representation using the quantitative data and/or the qualitative data. In some embodiments, system 1100 may include one or more software applications 1104 embodied in a device 1102 configured for association with machinery for performing operations 1106 of any embodiment disclosed herein. In some embodiments, a device 1102 configured for association with machinery may include hardware components positioned on the machinery and/or hardware components positioned off of the machinery. In some embodiments, a device 1102 configured for association with machinery may include components for electronically, wirelessly, mechanically, and/or otherwise controlling at least some operations of the machinery. In some embodiments, a device 1102 configured for association with machinery may be configured for association with a plurality of machines. In some embodiments, a device 1102 configured for association with machinery may include hardware components positioned on a plurality of machines, hardware components positioned off of the plurality of machines, and/or a combination of hardware components positioned on and/or off the plurality of machines. In some embodiments, a device 1102 configured for association with machinery may include components for electronically, wirelessly, mechanically, and/or otherwise controlling a least some operations of a plurality of machines. In some embodiments, a device 1102 may be configured for association with machinery such as cars, motorcycles, boats, aircraft, golf carts, personal flying machines, drones, vacuum cleaners, steam cleaners, floor polishers, sweepers, lawn mowers, hedge trimmers, edgers, blowers, bull dozers, diggers, backhoes, cranes, forklifts, security devices/cameras, service robots, and/or any other machine.

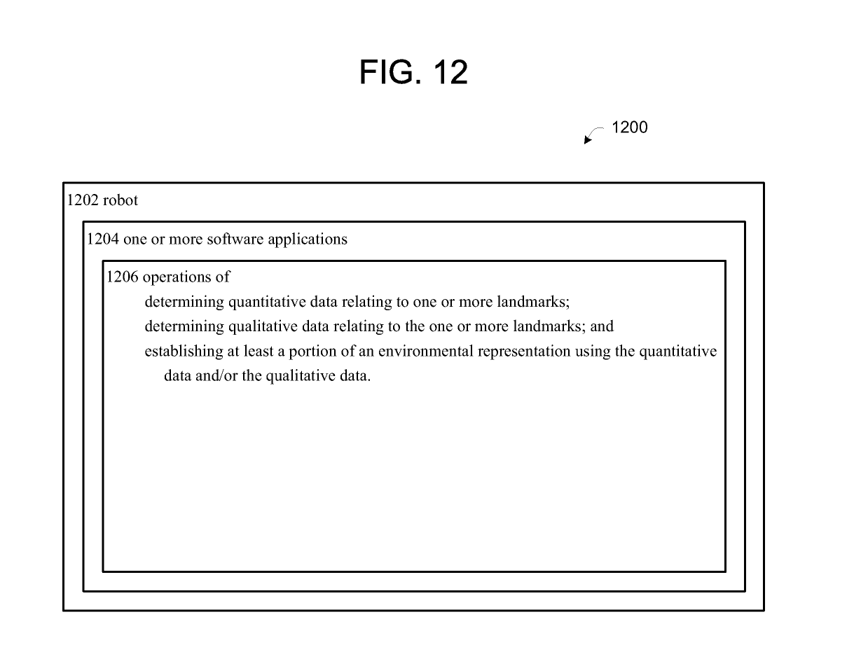

FIG. 12 is a system diagram of one or more software applications embodied in a robot for establishing an environmental representation, in accordance with an embodiment of the invention. In some embodiments, system 1200 may include one or more software applications 1204 embodied in a robot 1202 for performing operations 1206 of determining quantitative data relating to one or more landmarks; determining qualitative data relating to the one or more landmarks; and establishing at least a portion of an environmental representation using the quantitative data and/or the qualitative data. In some embodiments, system 1200 may include one or more software applications 1204 embodied in a robot 1202 for performing operations 1206 of any embodiment disclosed herein. In some embodiments, a robot 1202 may include one or more software applications 1204 located at least partially off the robot. In some embodiments, a robot 1202 may include one or more software applications 1204 for electronically, wirelessly, mechanically, and/or otherwise controlling at least some operations of the robot 1202. In some embodiments, a robot 1202 may include one or more software applications 1204 for electronically, wirelessly, mechanically, and/or otherwise controlling at least some operations of a plurality of robots. In some embodiments, a robot 1202 may be configured to perform transportation, cleaning, construction, industrial, commercial, retail, office, residential, personal, service, and/or other functions.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method comprising:
determining quantitative data relating to one or more landmarks;
determining qualitative data relating to the one or more landmarks; and
establishing at least a portion of an environmental representation using the quantitative data and/or the qualitative data.

2. The method of claim 1, wherein the determining quantitative data relating to one or more landmarks comprises:
determining quantitative data relating to one or more landmarks using one or more sensors.

3. The method of claim 1, wherein the determining quantitative data relating to one or more landmarks comprises:
determining quantitative data relating to one or more landmarks using user input.

4. The method of claim 1, wherein the determining quantitative data relating to one or more landmarks comprises:
determining quantitative data relating to one or more landmarks using one or more queries.

5. The method of claim 1, wherein the determining quantitative data relating to one or more landmarks comprises:
determining quantitative data relating to one or more landmarks using data input.

6. The method of claim 1, wherein the determining quantitative data relating to one or more landmarks comprises:
determining quantitative data relating to one or more corners, curved surfaces, and/or other irregularities.

7. The method of claim 1, wherein the determining quantitative data relating to one or more landmarks comprises:
determining one or more distances between two or more landmarks.

8. The method of claim 1, wherein the determining quantitative data relating to one or more landmarks comprises:
determining an existence of one or more open spaces between two or more landmarks.

9. The method of claim 1, wherein the determining quantitative data relating to one or more landmarks comprises:
determining one or more angles at the one or more landmarks.

10. The method of claim 1, wherein the determining quantitative data relating to one or more landmarks comprises:
determining one or more angles at the one or more landmarks with one or more other landmarks.

11. The method of claim 1, wherein the determining qualitative data relating to the one or more landmarks comprises:
determining qualitative data relating to the one or more landmarks using the determined quantitative data.

12. The method of claim 1, wherein the determining qualitative data relating to the one or more landmarks comprises:
determining qualitative data relating to the one or more landmarks based on previously determined qualitative data for one or more other landmarks.

13. The method of claim 1, wherein the determining qualitative data relating to the one or more landmarks comprises:
determining qualitative data relating to the one or more landmarks using one or more sensors.

14. The method of claim 1, wherein the determining qualitative data relating to the one or more landmarks comprises:
determining qualitative data relating to the one or more landmarks using user input.

15. The method of claim 1, wherein the determining qualitative data relating to the one or more landmarks comprises:
determining qualitative data relating to the one or more landmarks using one or more queries.

16. The method of claim 1, wherein the determining qualitative data relating to the one or more landmarks comprises:
determining qualitative data relating to the one or more landmarks using data input.

17. The method of claim 1, wherein the determining qualitative data relating to the one or more landmarks comprises:
determining qualitative data relating to the one or more landmarks using one or more images.

18. The method of claim 1, wherein the determining qualitative data relating to the one or more landmarks comprises:
determining qualitative data relating to one or more corners, curved surfaces, and/or other irregularities.

19. The method of claim 1, wherein the determining qualitative data relating to the one or more landmarks comprises:
determining one or more landmarks relating to the one or more landmarks.

20. The method of claim 1, wherein the determining qualitative data relating to the one or more landmarks comprises:
determining one or more landmarks within one or more regions relating to the one or more landmarks.

21. The method of claim 1, wherein the determining qualitative data relating to the one or more landmarks comprises:
determining one or more shapes, colors, and/or sizes relating to the one or more landmarks.

22. The method of claim 1, wherein the determining qualitative data relating to the one or more landmarks comprises:
determining one or more orientations, relative distances, and/or relative positions relating to the one or more landmarks.

23. The method of claim 1, wherein the determining qualitative data relating to the one or more landmarks comprises:
determining qualitative data relating to two or more landmarks.

24. The method of claim 1, wherein the establishing at least a portion of an environmental representation using the quantitative data and/or the qualitative data comprises:
establishing at least a portion of a human-readable environmental representation using the quantitative data and/or the qualitative data.

25. The method of claim 1, wherein the establishing at least a portion of an environmental representation using the quantitative data and/or the qualitative data comprises:
establishing at least a portion of a computer-readable environmental representation using the quantitative data and/or the qualitative data.

26. The method of claim 1, wherein the establishing at least a portion of an environmental representation using the quantitative data and/or the qualitative data comprises:
establishing at least a portion of a two-dimensional environmental representation using the quantitative data and/or the qualitative data.

27. The method of claim 1, wherein the establishing at least a portion of an environmental representation using the quantitative data and/or the qualitative data comprises:
establishing at least a portion of a three-dimensional environmental representation using the quantitative data and/or the qualitative data.

28. The method of claim 1, further comprising:
identifying the one or more landmarks from one or more positions using one or more sensors.

29. The method of claim 28, wherein the identifying the one or more landmarks from one or more positions using one or more sensors comprises:
identifying the one or more landmarks from one or more positions using one or more sensors positioned locally.

30. The method of claim 28, wherein the identifying the one or more landmarks from one or more positions using one or more sensors comprises:
identifying the one or more landmarks from one or more positions using one or more sensors positioned remotely.

31. The method of claim 28, wherein the identifying the one or more landmarks from one or more positions using one or more sensors comprises:
identifying the one or more landmarks from a series of positions using one or more sensors.

32. The method of claim 1, wherein the determining quantitative data relating to one or more landmarks comprises:
measuring quantitative data dependent upon one or more positions and relating to one or more landmarks; and
determining quantitative data independent from the one or more positions and relating to the one or more landmarks using the measured quantitative data.

33. The method of claim 1, wherein the operations are enabled by one or more software applications embodied in computer readable media.

34. The method of claim 1, wherein the operations are enabled by one or more software applications of a device configured for association with machinery.

35. The method of claim 1, wherein the operations are enabled by one or more software applications of a robot.
